(19) United States
(12) Patent Application Publication
(10) Pub. No.: US 2022/0011688 A1
(43) Pub. Date: Jan. 13, 2022

(54) ELECTROSTATIC INK COMPOSITION

(71) Applicant: Hewlett-Packard Development Company, L.P., Spring, TX (US)

(72) Inventors: Keren Goldshtein, Nes Ziona (IL); Gil BAR-HAIM, Nes Ziona (IL); David SAVELZON, Nes Ziona (IL); Tal ROSENTHAL, Nes Ziona (IL); Itay EYAL, Nes Ziona (IL); Reut AVIGDOR, Nes Ziona (IL)

(73) Assignee: Hewlett-Packard Development Company, L.P., Spring, TX (US)

(21) Appl. No.: 17/431,506

(22) PCT Filed: Sep. 27, 2019
(86) PCT No.: PCT/US2019/053619

§ 371 Date: Aug. 17, 2021

(51) Int. Cl. G03G 9/09; C09D 11/322; C09D 11/52; C09B 26/02; C09B 67/20

(52) U.S. Cl. CPC G03G 9/0924; C09D 11/322; C09B 67/0063; C09B 26/02; C09D 11/52

(57) ABSTRACT

Described herein is a yellow liquid electrophotographic ink composition comprising: a thermoplastic resin comprising a polymer having acidic side groups; and a colorant comprising a yellow pigment, wherein the yellow pigment comprises a hydrazone compound. Also described herein is a method of producing a printed substrate using the yellow liquid electrophotographic ink composition and a printed substrate produced therefrom.

### BACKGROUND

Electrophotographic printing processes, sometimes termed electrostatic printing processes, typically involve creating an image on a photoconductive surface, applying an ink having charged particles to the photoconductive surface, such that they selectively bind to the image, and then transferring the charged particles in the form of the image to a print substrate.

The photoconductive surface may be on a cylinder and is often termed a photo imaging plate (PIP). The photoconductive surface is selectively charged with a latent electrostatic image having image and background areas with different potentials. For example, an electrostatic ink composition including charged particles in a liquid carrier can be brought into contact with the selectively charged photoconductive surface. The charged particles adhere to the image areas of the latent image while the background areas remain clean. The image is then transferred to a print substrate (e.g., a polymer substrate) directly or by being first transferred to an intermediate transfer member, which can be a soft swelling blanket, which is often heated to fuse the solid image and evaporate the liquid carrier, and then to the print substrate.

Ink sets for printing can be based on the CMYK color model, with four inks (cyan, magenta, yellow, and key/black), though to access a particular pantone within the color gamut of a particular ink set, it can be necessary to print multiple impressions of a particular ink.

### BRIEF DESCRIPTION OF THE FIGURES

FIG. 1 is a graph showing peeling performance of Reference 1 and an Example liquid electrophotographic ink composition (20 wt. % particle loading, Sunbrite 2725157 as the Pigment Yellow 74) on a) coated paper (Condat 300 g/m²) and b) uncoated paper (Soperset).

### DETAILED DESCRIPTION

Before the present disclosure is disclosed and described, it is to be understood that this disclosure is not limited to the particular process steps and materials disclosed herein because such process steps and materials may vary somewhat. It is also to be understood that the terminology used herein is used for the purpose of describing particular embodiments. The terms are not intended to be limiting because the scope is intended to be limited by the appended claims and equivalents thereof.

It is noted that, as used in this specification and the appended claims, the singular forms “a,” “an,” and “the” include plural referents unless the context clearly dictates otherwise.

As used herein, “carrier fluid”, “carrier liquid,” “carrier,” or “carrier vehicle” refers to the fluid in which pigment particles, resin, charge directors and other additives can be dispersed to form a liquid electrostatic ink composition or liquid electrophotographic ink composition. The carrier liquids may include a mixture of a variety of different agents, such as surfactants, co-solvents, viscosity modifiers, and/or other possible ingredients.

As used herein, “liquid electrostatic ink composition” or “liquid electrophotographic composition” generally refers to an ink composition that is typically suitable for use in an electrostatic printing process, sometimes termed an electrophotographic printing process. It may comprise pigment particles having a thermoplastic resin thereon. The electrostatic ink composition may be a liquid electrostatic ink composition, in which the pigment particles having resin thereon are suspended in a carrier liquid. The pigment particles having resin thereon will typically be charged or capable of developing charge in an electric field, such that they display electrophoretic behaviour. A charge director may be present to impart a charge to the pigment particles having resin thereon.

As used herein, “co-polymer” refers to a polymer that is polymerized from at least two monomers. However, a copolymer of a particular list of monomer types (e.g., a copolymer of monomer A and monomer B) refers to a copolymer that is polymerized from monomers of those types and no other types of monomer (e.g., an AB polymer).

As used herein, “total base number” (TBN), sometimes simply referred to as base number, may be determined using standard techniques, including, those laid out in ASTM Designation D4739-08, such as Test Method D2896, Test Method D4739, and ASTM Designation D974-08, with Test Method D2896 being used if any discrepancy is shown between test methods, and unless otherwise stated, the test method(s) will be the most recently published at the time of filing this patent application. “mgKOH/g material” indicates “mgKOH per gram of dispersant”. The measurement of TBN of the dispersant can either be on the pure dispersant, or a dispersant in water or a hydrocarbon liquid, such as 60 wt. % dispersant in white spirit, e.g. dearomatized white spirit, mineral oil or distillate (e.g. C10-20 hydrocarbons), and then adjusted as if it had been measured on the pure dispersant.

As used herein, “melt flow rate” generally refers to the extrusion rate of a resin through an orifice of defined dimensions at a specified temperature and load, usually reported as temperature/load, e.g. 190° C./2.16 kg. Flow rates can be used to differentiate grades or provide a measure of degradation of a material as a result of molding. In the present disclosure, unless otherwise stated, “melt flow rate” is measured per ASTM D1238 Standard Test Method for Melt Flow Rates of Thermoplastics by Extrusion Plastometer, as known in the art. If a melt flow rate of a particular polymer is specified, unless otherwise stated, it is the melt flow rate for that polymer alone, in the absence of any of the other components of the liquid electrostatic ink composition.

As used herein, “acidity,” “acid number,” or “acid value” refers to the mass of potassium hydroxide (KOH) in milligrams that neutralizes one gram of a substance. The acidity of a polymer can be measured according to standard techniques, for example as described in ASTM D1386. If the acidity of a particular polymer is specified, unless otherwise stated, it is the acidity for that polymer alone, in the absence of any of the other components of the liquid toner composition.

As used herein, “melt viscosity” generally refers to the ratio of shear stress to shear rate at a given shear stress or shear rate. Testing is generally performed using a capillary rheometer. A plastic charge is heated in the rheometer barrel and is forced through a die with a plunger. The plunger is pushed either by a constant force or at constant rate depending on the equipment. Measurements are taken once the system has reached steady-state operation. One method used is measuring Brookfield viscosity @ 140° C., units are mPa·s or cPoise, as known in the art. Alternatively, the melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate. If the melt viscosity of a particular polymer is specified, unless otherwise stated, it is the melt viscosity for that polymer alone, in the absence of any of the other components of the electrostatic composition.

A certain monomer may be described herein as constituting a certain weight percentage of a polymer. This indicates that the repeating units formed from the said monomer in the polymer constitute said weight percentage of the polymer.

If a standard test is mentioned herein, unless otherwise stated, the version of the test to be referred to is the most recent at the time of filing this patent application.

As used herein, “liquid electrostatic(ally) printing” or “liquid electrophotographic(ally) printing” generally refers to the process that provides an image that is transferred from a photo imaging substrate or plate either directly or indirectly via an intermediate transfer member to a print substrate, for example a polymer substrate. As such, the image is not substantially absorbed into the photo imaging substrate on which it is applied. Additionally, “liquid electrophotographic printers” or “liquid electrostatic printers” generally refer to those printers capable of performing electrophotographic printing or electrostatic printing, as described above. A liquid electrophotographic (LEP) printing process may involve subjecting a liquid electrophotographic ink composition to an electric field, for example, an electric field having a field gradient of 50-400 V/μm, or more, in some examples, 600-900V/μm, or more, in some examples, 1000 V/cm or more, in some examples, 1000V/mm or more.

As used herein, “LEP image” or “printed LEP image” refer to an image which has been printed, for example, on a print substrate, by liquid electrophotographically printing a LEP ink composition described herein.

As used herein, “NVS” is an abbreviation of the term “non-volatile solids”.

As used herein, the term “about” is used to provide flexibility to a numerical range endpoint by providing that a given value may be a little above or a little below the endpoint to allow for variation in test methods or apparatus. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not just the numerical values explicitly recited as the limits of the range, but also to include all the individual numerical values or sub-ranges encompassed within that range as if each numerical value and sub-range is explicitly recited. As an illustration, a numerical range of “about 1 wt. % to about 5 wt. %” should be interpreted to include not just the explicitly recited values of about 1 wt. % to about 5 wt. %, but also to include individual values and sub-ranges within the indicated range. Thus, included in this numerical range are individual values such as 2, 3.5, and 4 and sub-ranges such as from 1-3, from 2-4, and from 3-5, etc. This same principle applies to ranges reciting a single numerical value. Furthermore, such an interpretation should apply regardless of the breadth of the range or the characteristics being described.

As used herein, unless otherwise stated, wt. % values are to be taken as referring to a weight-for-weight (w/w) percentage of solids in the ink composition, and not including the weight of any carrier fluid present.

Unless otherwise stated, any feature described herein can be combined with any aspect or any other feature described herein.

In an aspect, there is provided a yellow liquid electrophotographic ink composition comprising:
a thermoplastic resin comprising a polymer having acidic side groups; and
a colorant comprising a yellow pigment, wherein the yellow pigment comprises a hydrazone compound.

In another aspect, there is provided a printed substrate comprising:
a substrate; and
a yellow liquid electrophotographically printed image disposed thereon; wherein
the yellow liquid electrophotographically printed ink composition comprises:
   a thermoplastic resin comprising a polymer having acidic side groups; and
   a colorant comprising a yellow pigment, wherein the yellow pigment comprises a hydrazone compound.

In a further aspect, there is provided a method of producing a printed substrate comprising:
applying a yellow liquid electrophotographic ink composition to a substrate with a liquid electrophotographic printer;
wherein the yellow liquid electrophotographic ink composition comprises:
   a thermoplastic resin comprising a polymer having acidic side groups; and
   a colorant comprising a yellow pigment, wherein the yellow pigment comprises a hydrazone compound.

Yellow liquid electrophotographic ink compositions comprise yellow pigments comprising isoindoline compounds, for example, Pigment Yellow 185 and Pigment Yellow 139. When printed with cyan, magenta and black/key liquid electrophotographic ink compositions (CMYK printing), these pigments do not allow the full color gamut to be achieved. It has been found that yellow liquid electrophotographic ink compositions based on hydrazone compounds increase the chroma and lightness of the inks. Additionally, the transfer of liquid electrophotographic ink compositions comprising a yellow pigment comprising a hydrazone compound from the intermediate transfer member of a liquid electrostatic printer to the substrate is improved, in particular at higher pigment loadings that could be achieved with liquid electrophotographic ink compositions comprising a yellow pigment comprising isoindoline compounds. Furthermore, the resistance of yellow liquid electrophotographically printed ink compositions to peeling also increased. As a result, smaller quantities of yellow liquid electrophotographic ink composition comprising a hydrazine compound could be used to provide a particular optical density.

### Yellow Liquid Electrophotographic Ink Composition

The yellow liquid electrophotographic (LEP) ink composition may comprise a thermoplastic resin comprising a polymer having acidic side groups; and a colorant comprising a yellow pigment, wherein the yellow pigment comprises a hydrazone compound.

In some examples, the yellow LEP ink composition may comprise a liquid carrier; a thermoplastic resin comprising a polymer having acidic side groups; and a colorant comprising a yellow pigment, wherein the yellow pigment comprises a hydrazone compound. The yellow LEP ink composition may comprise a liquid carrier and chargeable particles suspended in the liquid carrier, the chargeable particles comprising a thermoplastic resin and a colorant. The chargeable particles may comprise a thermoplastic resin comprising a polymer having acidic side groups and a colorant comprising a yellow pigment, wherein the yellow pigment comprises a hydrazone compound.

In some examples, the yellow LEP ink composition further comprises a dispersant. In some examples, the yellow LEP ink composition may comprise a thermoplastic resin comprising a polymer having acidic side groups; a colorant comprising a yellow pigment, wherein the yellow pigment comprises a hydrazone compound; and a dispersant. In some examples, the yellow LEP ink composition comprises a thermoplastic resin comprising a polymer having acidic side groups; a colorant comprising a yellow pigment, wherein the yellow pigment comprises a hydrazone compound; a dispersant; and a liquid carrier.

In some examples, the yellow LEP ink composition may further comprise a charge director. In some examples, the yellow LEP ink composition may comprise a thermoplastic resin; a colorant and a charge director. In some examples, the yellow LEP ink composition may comprise a thermoplastic resin; a colorant, a dispersant; and a charge director. In some examples, the yellow LEP ink composition may comprise a thermoplastic resin, a colorant, a liquid carrier, and a charge director. In some examples, the yellow LEP ink composition may comprise a thermoplastic resin; a colorant; a liquid carrier; a dispersant; and a charge director.

In some examples, the yellow LEP ink composition may further comprise a charge adjuvant. In some examples, the yellow LEP ink composition may comprise a thermoplastic resin; a colorant and a charge adjuvant. In some examples, the yellow LEP ink composition may comprise a thermoplastic resin; a colorant; a dispersant; and a charge adjuvant. In some examples, the yellow LEP ink composition may comprise a thermoplastic resin, a colorant, a charge adjuvant and a liquid carrier. In some examples, the yellow LEP ink composition may comprise a thermoplastic resin, a colorant, a charge adjuvant, a liquid carrier, and a dispersant. In some examples, the yellow LEP ink composition may comprise a thermoplastic resin, a colorant, a charge adjuvant and a charge director. In some examples, the yellow LEP ink composition may comprise a thermoplastic resin; a colorant; a dispersant; a charge adjuvant, and a charge director. In some examples, the yellow LEP ink composition may comprise a thermoplastic resin, a colorant, a charge adjuvant, a charge director and a liquid carrier. In some examples, the yellow LEP ink composition may comprise a thermoplastic resin, a colorant, a charge adjuvant, a charge director, a dispersant and a liquid carrier.

In some examples, the yellow LEP ink composition may further comprise additives.

Colorant

The colorant comprises a yellow pigment, wherein the yellow pigment comprises a hydrazone compound. In some examples, the yellow pigment consists of a hydrazone compound. As used herein, a hydrazone compound is a compound containing at least one hydrazone group.

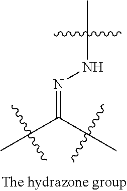 [SMILES: *NN=C(*)*]

Pigments comprising a hydrazone group were previously considered to comprise the tautomeric form, that is, these pigments were considered to be azo compounds:

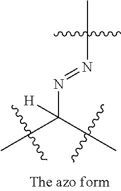 [SMILES: */N=N/C(*)*]

In some examples, the yellow pigment comprises a hydrazone compound of Formula I:

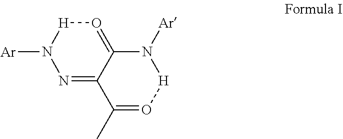

wherein Ar and Ar′ are substituted or unsubstituted aryl groups. In some examples, Ar and Ar′ may be the same or different. In some examples, Ar and Ar′ may be substituted aryl groups, wherein the substituents are independently selected from C1 to C3 alkyl groups, C1 to C3 alkoxy groups, nitro groups and halogens. In some examples, the aryl groups may be substituted or unsubstituted C5 to C8 aryl groups, for example, substituted or unsubstituted benzyl rings.

In some examples, the yellow pigment comprises a hydrazone compound of Formula Ia:

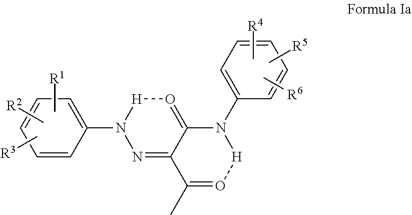

wherein R¹ to R⁶ are each independently selected from a hydrogen atom, a C1 to C3 alkyl group, a C1 to C3 alkoxy group, a nitro group and a halogen group.

In some examples, at least one of R¹ to R³ is a nitro group. In some examples, the nitro group is para to the hydrazone group.

In some examples, at least one of R¹ to R⁶ is a C1 to C3 alkoxy group, for example, a methoxy group. In some examples, one of R¹ to R⁶ is a C1 to C3 alkoxy group, for example, a methoxy group. In some examples, at least one of R¹ to R³ is a C1 to C3 alkoxy group, for example, a methoxy group. In some examples, one of R¹ to R³ is a C1 to C3 alkoxy group, for example, a methoxy group. In some examples, at least one of R⁴ to R⁶ is a C1 to C3 alkoxy group, for example, a methoxy group. In some examples, one of R⁴ to R⁶ is a C1 to C3 alkoxy group, for example, a methoxy group. In some examples, two of R⁴ to R⁶ are independently C1 to C3 alkoxy groups, for example, methoxy groups.

In some examples, at least one of R¹ to R³ is a C1 to C3 alkoxy group, for example, a methoxy group, and at least one of R⁴ to R⁶ is a C1 to C3 alkoxy group, for example, a methoxy group. In some examples, one of R¹ to R³ is a C1 to C3 alkoxy group, for examples, a methoxy group, and one of R⁴ to R⁶ is a C1 to C3 alkoxy group, for example, a methoxy group.

In some examples, at least one of R¹ to R³ is a nitro group and at least one of R¹ to R⁶ is a C1 to C3 alkoxy group, for example, a methoxy group. In some examples, at least one of R¹ to R³ is a nitro group and one of R¹ to R⁶ is a C1 to C3 alkoxy group, for example, a methoxy group. In some examples, at least one of R¹ to R³ is a nitro group and at least one of R¹ to R³ is a C1 to C3 alkoxy group, for example, a methoxy group. In some examples, at least one of R¹ to R³ is a nitro group and one of R¹ to R³ is a C1 to C3 alkoxy group, for example, a methoxy group. In some examples, at least one of R¹ to R³ is a nitro group and at least one of R⁴ to R⁶ is a C1 to C3 alkoxy group, for example, a methoxy group. In some examples, at least one of R¹ to R³ is a nitro group and one of R⁴ to R⁶ is a C1 to C3 alkoxy group, for example, a methoxy group. In some examples, at least one of R¹ to R³ is a nitro group and two of R⁴ to R⁶ are independently C1 to C3 alkoxy groups, for example, methoxy groups. In some examples, at least one of R¹ to R³ is a nitro group and at least one of R¹ to R³ is a C1 to C3 alkoxy group, for example, a methoxy group, and at least one of R⁴ to R⁶ is a C1 to C3 alkoxy group, for example, a methoxy group. In some examples, at least one of R¹ to R³ is a nitro group and one of R¹ to R³ is a C1 to C3 alkoxy group, for example, a methoxy group and one of R⁴ to R⁶ is a C1 to C3 alkoxy group, for example, a methoxy group.

In some examples, the yellow pigment comprises a hydrazone compound of Formula Ib:

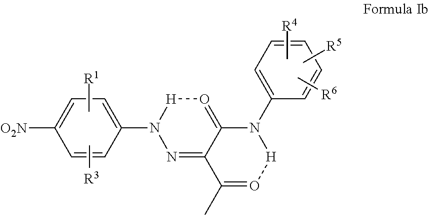

wherein R¹ and R³ to R⁶ are each independently selected from a hydrogen atom, a C1 to C3 alkyl group, a C1 to C3 alkoxy group, a nitro group and a halogen group. In some examples, the yellow pigment comprises a hydrazone compound of Formula Ib and R¹ and R³ to R⁶ are independently selected from a hydrogen atom, a C1 to C3 alkoxy group (e.g., a methoxy group) and a halogen group (e.g., chloride). In some examples, the yellow pigment comprises a hydrazone compound of Formula Ib and at least one or R¹ and R³ is a C1 to C3 alkoxy group (e.g., a methoxy group) and at least one of R⁴ to R⁶ is a C1 to C3 alkoxy group (e.g., a methoxy group).

In some examples, the yellow pigment comprises a hydrazone compound selected from Formulae II:

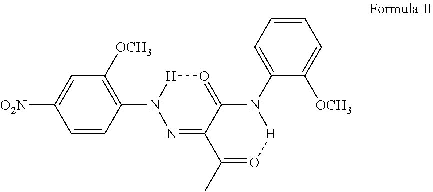

In some examples, the yellow pigment consists of a hydrazone compound of Formula II.

In some examples, the yellow pigment is Pigment Yellow 74.

In some examples, the yellow liquid electrophotographic ink composition comprises the colorant in an amount of up to about 40 wt. % of the non-volatile solids of the yellow liquid electrophotographic ink composition, for example, about 35 wt. % or less, about 30 wt. % or less, about 29 wt. % or less, about 28 wt. % or less, about 27 wt. % or less, about 26 wt. % or less, about 25 wt. % or less, about 24 wt. % or less, about 23 wt. % or less, about 22 wt. % or less, about 21 wt. % or less, about 20 wt. % or less, about 15 wt. % or less, or about 10 wt. % or less of the non-volatile solids of the liquid electrophotographic ink composition. In some examples, the yellow liquid electrophotographic ink composition comprises the colorant in an amount of about 10 wt. % or more of the non-volatile solids of the yellow liquid electrophotographic ink composition, for example, about 15 wt. % or more, about 20 wt. % or more, about 21 wt. % or more, about 22 wt. % or more, about 23 wt. % or more, about 24 wt. % or more, about 25 wt. % or more, about 26 wt. % or more, about 27 wt. % or more, about 28 wt. % or more, about 29 wt. % or more, about 30 wt. % or more, about 35 wt. % or more, or about 40 wt. % or more. In some examples, the yellow liquid electrophotographic ink composition comprises the colorant in an amount of from about 10 wt. % to about 40 wt. % of the non-volatile solids of the liquid electrophotographic ink composition, for example, about 15 wt. % to about 35 wt. %, about 20 wt. % to about 30 wt. %, about 21 wt. % to about 29 wt. %, about 22 wt. % to about 28 wt. %, about 23 wt. % to about 27 wt. %, about 24 wt. % to about 26 wt. %, or about 25 wt. % to about 30 wt. % of the non-volatile solids of the liquid electrophotographic ink composition.

In some examples, the colorant may comprise yellow pigment and a resin, for example, a thermoplastic resin. In some examples, the colorant may comprise yellow pigment, a resin and additives. In some examples, the colorant may consist of the yellow pigment.

In some examples, the colorant comprises at least 50 wt. % yellow pigment, for example, at least 60 wt. %, at least 65 wt. %, at least 70 wt. %, at least 75 wt. %, at least 80 wt. %, at least 85 wt. %, at least 90 wt. %, at least 91 wt. %, at least 92 wt. %, at least 93 wt. %, at least 94 wt. %, at least 95 wt. %, at least 96 wt. %, at least 97 wt. %, at least 98 wt. %, at least 99 wt. % at least 99.5 wt. % or at least 99.9 wt. % yellow pigment. In some examples, the colorant comprises 99.9 wt. % or less yellow pigment, for example, 99.5 wt. % or less, 99 wt. % or less, 98 wt. % or less, 97 wt. % or less, 96 wt. % or less, 95 wt. % or less, 94 wt. % or less, 93 wt. % or less, 92 wt. % or less, 91 wt. % or less, 90 wt. % or less, 95 wt. % or less, 90 wt. % or less, 85 wt. % or less, 80 wt. % or less, 75 wt. % or less, 70 wt. % or less, 65 wt. % or less, 60 wt. % or less or 50 wt. % or less yellow pigment. In some examples, the colorant comprises from 50 wt. % to 99.9 wt. % yellow pigment, for example, from 60 wt. % to 99.5 wt. %, 65 wt. % to 99 wt. %, 70 wt. % to 98 wt. %, 75 wt. % to 97 wt. %, 80 wt. % to 96 wt. %, 85 wt. % to 95 wt. %, 90 wt. % to 94 wt. %, 91 wt. % to 93 wt. %, or 92 wt. % to 99 wt. % yellow pigment.

In some examples, the yellow pigment is Pigment Yellow 74. In some examples, the Pigment Yellow 74 is Ink jet GX-W (available from Clariant), Toner GX (available from Clariant), Sunbrite 2725147 (available from Sun Chemical) or Sunbrite 2725157 (available from Sun Chemical). Further sources of Pigment Yellow 74 include Rex-ton company, Heubach, Sanyo Color and Sudarshan company (India).

Thermoplastic Resin

The yellow liquid electrophotographic ink composition comprises a thermoplastic resin. In some examples, the thermoplastic resin comprises a polymer having acidic side groups. The thermoplastic resin may be referred to herein as a resin.

In some examples, the yellow LEP ink composition comprises chargeable particles (i.e., having or capable of developing a charge, for example, in an electromagnetic field) including the thermoplastic resin and, in some examples, the colorant.

In some examples, the thermoplastic resin may comprise a polymer selected from ethylene acrylic acid copolymers; ethylene methacrylic acid copolymers; ethylene vinyl acetate copolymers; copolymers of ethylene (e.g. 80 wt. % to 99.9 wt. %), and alkyl (e.g. C1 to C5) ester of methacrylic or acrylic acid (e.g. 0.1 wt. % to 20 wt. %); copolymers of ethylene (e.g. 80 wt. % to 99.9 wt. %), acrylic or methacrylic acid (e.g. 0.1 wt. % to 20 wt. %) and alkyl (e.g. C1 to C5) ester of methacrylic or acrylic acid (e.g. 0.1 wt. % to 20 wt. %); polyethylene; polystyrene; isotactic polypropylene (crystalline); ethylene ethyl acrylate; polyesters; polyvinyl toluene; polyamides; styrene/butadiene copolymers; epoxy resins; acrylic resins (e.g. copolymer of acrylic or methacrylic acid and at least one alkyl ester of acrylic or methacrylic acid wherein alkyl is, in some examples, from 1 to about 20 carbon atoms, such as methyl methacrylate (e.g. 50 wt. % to 90 wt. %)/methacrylic acid (e.g. 0 wt. % to 20 wt. %)/ethylhexylacrylate (e.g. 10 wt. % to 50 wt. %)); ethylene-acrylate terpolymers: ethylene-acrylic esters-maleic anhydride (MAH) or glycidyl methacrylate (GMA) terpolymers; ethylene-acrylic acid ionomers and combinations thereof.

The polymer having acidic side groups may have an acidity of 50 mg KOH/g or more, in some examples an acidity of 60 mg KOH/g or more, in some examples an acidity of 70 mg KOH/g or more, in some examples an acidity of 80 mg KOH/g or more, in some examples an acidity of 90 mg KOH/g or more, in some examples an acidity of 100 mg KOH/g or more, in some examples an acidity of 105 mg KOH/g or more, in some examples 110 mg KOH/g or more, in some examples 115 mg KOH/g or more. The polymer having acidic side groups may have an acidity of 200 mg KOH/g or less, in some examples 190 mg or less, in some examples 180 mg or less, in some examples 130 mg KOH/g or less, in some examples 120 mg KOH/g or less. Acidity of a polymer, as measured in mg KOH/g, can be measured using standard procedures known in the art, for example, using the procedure described in ASTM D1386.

The thermoplastic resin may comprise a polymer having acidic side groups that has a melt flow rate of less than about 60 g/10 minutes, in some examples about 50 g/10 minutes or less, in some examples about 40 g/10 minutes or less, in some examples 30 g/10 minutes or less, in some examples 20 g/10 minutes or less, in some examples 10 g/10 minutes or less. In some examples, all polymers having acidic side groups and/or ester groups in the particles each individually have a melt flow rate of less than 90 g/10 minutes, 80 g/10 minutes or less, in some examples 70 g/10 minutes or less, in some examples 60 g/10 minutes or less.

The polymer having acidic side groups can have a melt flow rate of about 10 g/10 minutes to about 120 g/10 minutes, in some examples about 10 g/10 minutes to about 70 g/10 minutes, in some examples about 10 g/10 minutes to 40 g/10 minutes, in some examples 20 g/10 minutes to 30 g/10 minutes. The polymer having acidic side groups can have a melt flow rate of in some examples about 50 g/10 minutes to about 120 g/10 minutes, in some examples 60 g/10 minutes to about 100 g/10 minutes. The melt flow rate can be measured using standard procedures known in the art, for example, as described in ASTM D1238.

The thermoplastic resin may comprise a copolymer of an alkylene monomer and a monomer having acidic side groups. In some examples, the alkylene monomer may be selected from ethylene and propylene. In some examples, the monomer having acidic side groups may be selected from methacrylic acid and acrylic acid. In some examples, the thermoplastic resin may comprise a copolymer of an alkylene monomer and a monomer selected from methacrylic acid and acrylic acid. In some examples, the thermoplastic resin may comprise a copolymer of ethylene and a monomer selected from methacrylic acid and acrylic acid.

In some examples, the polymer having acidic side groups is a copolymer of an alkylene monomer and a monomer selected from acrylic acid and methacrylic acid. In some examples, the thermoplastic resin may comprise a copolymer of an alkylene monomer and a monomer selected from acrylic acid and methacrylic acid.

The acidic side groups may be in free acid form or may be in the form of an anion and associated with one or more counterions, typically metal counterions, e.g. a metal selected from the alkali metals, such as lithium, sodium and potassium, alkali earth metals, such as magnesium or calcium, and transition metals, such as zinc. The polymer having acidic side groups can be selected from resins such as copolymers of ethylene and an ethylenically unsaturated acid of either acrylic acid or methacrylic acid; and ionomers thereof, such as methacrylic acid and ethylene-acrylic or methacrylic acid copolymers which are at least partially neutralized with metal ions (e.g. Zn, Na, Li) such as SURLYN® ionomers. The polymer comprising acidic side groups can be a copolymer of ethylene and an ethylenically unsaturated acid of either acrylic or methacrylic acid, where the ethylenically unsaturated acid of either acrylic or methacrylic acid constitute from 5 wt. % to about 25 wt. % of the copolymer, in some examples from 10 wt. % to about 20 wt. % of the copolymer.

The thermoplastic resin may comprise two different polymers having acidic side groups. The two polymers having acidic side groups may have different acidities, which may fall within the ranges mentioned above. The thermoplastic resin may comprise a first polymer having acidic side groups that has an acidity of from 50 mg KOH/g to 110 mg KOH/g and a second polymer having acidic side groups that has an acidity of 110 mg KOH/g to 130 mg KOH/g.

The resin may comprise two different polymers having acidic side groups: a first polymer having acidic side groups that has a melt flow rate of about 10 g/10 minutes to about 50 g/10 minutes and an acidity of from 50 mg KOH/g to 110 mg KOH/g, and a second polymer having acidic side groups that has a melt flow rate of about 50 g/10 minutes to about 120 g/10 minutes and an acidity of 110 mg KOH/g to 130 mg KOH/g. The first and second polymers may be absent of ester groups.

The resin may comprise a copolymer of ethylene and acrylic acid and a copolymer of ethylene and methacrylic acid.

The resin may comprise two different polymers having acidic side groups: a first polymer that is a copolymer of ethylene (e.g. 92 to 85 wt. %, in some examples about 89 wt. %) and acrylic or methacrylic acid (e.g. 8 to 15 wt. %, in some examples about 11 wt. %) having a melt flow rate of 80 to 110 g/10 minutes and a second polymer that is a copolymer of ethylene (e.g. about 80 to 92 wt. %, in some examples about 85 wt. %) and acrylic acid (e.g. about 18 to 12 wt. %, in some examples about 15 wt. %), having a melt viscosity lower than that of the first polymer, the second polymer for example having a melt viscosity of 15000 poise or less, in some examples a melt viscosity of 10000 poise or less, in some examples 1000 poise or less, in some examples 100 poise or less, in some examples 50 poise or less, in some examples 10 poise or less. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

In any of the resins mentioned above, the ratio of the first polymer having acidic side groups to the second polymer having acidic side groups can be from about 10:1 to about 2:1. In another example, the ratio can be from about 6:1 to about 3:1, in some examples about 4:1.

The resin may comprise a polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; said polymer may be a polymer having acidic side groups as described herein. The resin may comprise a first polymer having a melt viscosity of 15000 poise or more, in some examples 20000 poise or more, in some examples 50000 poise or more, in some examples 70000 poise or more; and in some examples, the resin may comprise a second polymer having a melt viscosity less than the first polymer, in some examples a melt viscosity of 15000 poise or less, in some examples a melt viscosity of 10000 poise or less, in some examples 1000 poise or less, in some examples 100 poise or less, in some examples 50 poise or less, in some examples 10 poise or less. The resin may comprise a first polymer having a melt viscosity of more than 60000 poise, in some examples from 60000 poise to 100000 poise, in some examples from 65000 poise to 85000 poise; a second polymer having a melt viscosity of from 15000 poise to 40000 poise, in some examples 20000 poise to 30000 poise, and a third polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 960 (from DuPont), an example of the second polymer is Nucrel 699 (from DuPont), and an example of the third polymer is AC-5120 (from Honeywell). In some examples, the resin may comprise a first polymer having a melt viscosity of from 15000 poise to 40000 poise, in some examples 20000 poise to 30000 poise, and a second polymer having a melt viscosity of 15000 poise or less, in some examples a melt viscosity of 10000 poise or less, in some examples 1000 poise or less, in some examples 100 poise or less, in some examples 50 poise or less, in some examples 10 poise or less; an example of the first polymer is Nucrel 699 (from DuPont), and an example of the second polymer is AC-5120 (from Honeywell). The first, second and third polymers may be polymers having acidic side groups as described herein. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

If the resin comprises a single type of resin polymer, the resin polymer (excluding any other components of the electrostatic ink composition) may have a melt viscosity of 6000 poise or more, in some examples a melt viscosity of 8000 poise or more, in some examples a melt viscosity of 10000 poise or more, in some examples a melt viscosity of 12000 poise or more. If the resin comprises a plurality of polymers all the polymers of the resin may together form a mixture (excluding any other components of the electrostatic ink composition) that has a melt viscosity of 6000 poise or more, in some examples a melt viscosity of 8000 poise or more, in some examples a melt viscosity of 10000 poise or more, in some examples a melt viscosity of 12000 poise or more. Melt viscosity can be measured using standard techniques. The melt viscosity can be measured using a rheometer, e.g. a commercially available AR-2000 Rheometer from Thermal Analysis Instruments, using the geometry of: 25 mm steel plate-standard steel parallel plate, and finding the plate over plate rheometry isotherm at 120° C., 0.01 Hz shear rate.

The resin may comprise two different polymers having acidic side groups that are selected from copolymers of ethylene and an ethylenically unsaturated acid of either methacrylic acid or acrylic acid; and ionomers thereof, such as methacrylic acid and ethylene-acrylic or methacrylic acid copolymers which are at least partially neutralized with metal ions (e.g. Zn, Na, Li) such as SURLYN® ionomers.

The resin may comprise (i) a first polymer that is a copolymer of ethylene and an ethylenically unsaturated acid of either acrylic acid and methacrylic acid, wherein the ethylenically unsaturated acid of either acrylic or methacrylic acid constitutes from 8 wt. % to about 16 wt. % of the copolymer, in some examples 10 wt. % to 16 wt. % of the copolymer; and (ii) a second polymer that is a copolymer of ethylene and an ethylenically unsaturated acid of either acrylic acid and methacrylic acid, wherein the ethylenically unsaturated acid of either acrylic or methacrylic acid constitutes from 12 wt. % to about 30 wt. % of the copolymer, in some examples from 14 wt. % to about 20 wt. % of the copolymer, in some examples from 16 wt. % to about 20 wt. % of the copolymer in some examples from 17 wt. % to 19 wt. % of the copolymer.

In an example, the resin constitutes about 5 to 90%, in some examples about 5 to 80% by weight of the total solids of the electrostatic ink composition. In another example, the resin constitutes about 10 to 60% by weight of the total solids of the electrostatic ink composition. In another example, the resin constitutes about 15 to 40% by weight of the total solids of the electrostatic ink composition. In another example, the resin constitutes about 60 to 95% by weight, in some examples, from 65 to 90% by weight, from 65 to 80% by weight of the total solids of the electrostatic ink composition.

The resin may comprise a polymer having acidic side groups, as described above (which may be free of ester side groups), and a polymer having ester side groups. The polymer having ester side groups is, in some examples, a thermoplastic polymer. The polymer having ester side groups may further comprise acidic side groups. The polymer having ester side groups may be a copolymer of a monomer having ester side groups and a monomer having acidic side groups. The polymer may be a copolymer of a monomer having ester side groups, a monomer having acidic side groups, and a monomer absent of any acidic and ester side groups. The monomer having ester side groups may be a monomer selected from esterified acrylic acid or esterified methacrylic acid. The monomer having acidic side groups may be a monomer selected from acrylic or methacrylic acid. The monomer absent of any acidic and ester side groups may be an alkylene monomer, including, but not limited to, ethylene or propylene. The esterified acrylic acid or esterified methacrylic acid may, respectively, be an alkyl ester of acrylic acid or an alkyl ester of methacrylic acid. The alkyl group in the alkyl ester of acrylic or methacrylic acid may be an alkyl group having 1 to 30 carbons, in some examples 1 to 20 carbons, in some examples 1 to 10 carbons; in some examples selected from methyl, ethyl, iso-propyl, n-propyl, t-butyl, iso-butyl, n-butyl and pentyl.

The polymer having ester side groups may be a copolymer of a first monomer having ester side groups, a second monomer having acidic side groups and a third monomer which is an alkylene monomer absent of any acidic and ester side groups. The polymer having ester side groups may be a copolymer of (i) a first monomer having ester side groups selected from esterified acrylic acid or esterified methacrylic acid, in some examples an alkyl ester of acrylic or methacrylic acid, (ii) a second monomer having acidic side groups selected from acrylic or methacrylic acid and (iii) a third monomer which is an alkylene monomer selected from ethylene and propylene. The first monomer may constitute 1 to 50% by weight of the copolymer, in some examples 5 to 40% by weight, in some examples 5 to 20% by weight of the copolymer, in some examples 5 to 15% by weight of the copolymer. The second monomer may constitute 1 to 50% by weight of the copolymer, in some examples 5 to 40% by weight of the copolymer, in some examples 5 to 20% by weight of the copolymer, in some examples 5 to 15% by weight of the copolymer. In an example, the first monomer constitutes 5 to 40% by weight of the copolymer, the second monomer constitutes 5 to 40% by weight of the copolymer, and with the third monomer constituting the remaining weight of the copolymer. In an example, the first monomer constitutes 5 to 15% by weight of the copolymer, the second monomer constitutes 5 to 15% by weight of the copolymer, with the third monomer constituting the remaining weight of the copolymer. In an example, the first monomer constitutes 8 to 12% by weight of the copolymer, the second monomer constitutes 8 to 12% by weight of the copolymer, with the third monomer constituting the remaining weight of the copolymer. In an example, the first monomer constitutes about 10% by weight of the copolymer, the second monomer constitutes about 10% by weight of the copolymer, and with the third monomer constituting the remaining weight of the copolymer. The polymer having ester side groups may be selected from the Bynel® class of monomer, including Bynel 2022 and Bynel 2002, which are available from DuPont®.

The polymer having ester side groups may constitute 1% or more by weight of the total amount of the resin polymers in the resin, e.g. the total amount of the polymer or polymers having acidic side groups and polymer having ester side groups. The polymer having ester side groups may constitute 5% or more by weight of the total amount of the resin polymers in the resin, in some examples 8% or more by weight of the total amount of the resin polymers in the resin, in some examples 10% or more by weight of the total amount of the resin polymers in the resin, in some examples 15% or more by weight of the total amount of the resin polymers in the resin, in some examples 20% or more by weight of the total amount of the resin polymers in the resin, in some examples 25% or more by weight of the total amount of the resin polymers in the resin, in some examples 30% or more by weight of the total amount of the resin polymers in the resin, in some examples 35% or more by weight of the total amount of the resin polymers in the resin. The polymer having ester side groups may constitute from 5% to 50% by weight of the total amount of the resin polymers in the resin, in some examples 10% to 40% by weight of the total amount of the resin polymers in the resin, in some examples 15% to 30% by weight of the total amount of the polymers in the resin.

The polymer having ester side groups may have an acidity of 50 mg KOH/g or more, in some examples an acidity of 60 mg KOH/g or more, in some examples an acidity of 70 mg KOH/g or more, in some examples an acidity of 80 mg KOH/g or more. The polymer having ester side groups may have an acidity of 100 mg KOH/g or less, in some examples 90 mg KOH/g or less. The polymer having ester side groups may have an acidity of 60 mg KOH/g to 90 mg KOH/g, in some examples 70 mg KOH/g to 80 mg KOH/g.

The polymer having ester side groups may have a melt flow rate of about 10 g/10 minutes to about 120 g/10 minutes, in some examples about 10 g/10 minutes to about 50 g/10 minutes, in some examples about 20 g/10 minutes to about 40 g/10 minutes, in some examples about 25 g/10 minutes to about 35 g/10 minutes.

In an example, the polymer or polymers of the resin can be selected from the Nucrel family of toners (e.g. Nucrel 403™, Nucrel407™, Nucrel 609HS™, Nucrel 908HS™ Nucrel 1202HC™, Nucrel30707™, Nucrel1214™, Nucrel 903™, Nucrel 3990™, Nucrel910™, Nucrel925™, Nucrel699™, Nucrel599™, Nucrel960™, Nucrel RX 76™, Nucrel2806™, Bynell 2002, Bynell 2014, and Bynell 2020 (sold by E. I. du PONT)), the Aclyn family of toners (e.g. Aclyn 201, Aclyn 246, Aclyn 285, and Aclyn 295), AC-5120 and AC 580 (sold by Honeywell), and the Lotader family of toners (e.g. Lotader 2210, Lotader, 3430, and Lotader 8200 (sold by Arkema)).

In some examples, the resin may constitute 5% to 99% by weight of the total solids in the yellow LEP ink composition, in some examples 50% to 90% by weight of the total solids of the yellow LEP ink composition, in some examples 65% to 80% by weight of the total solids of the yellow LEP ink composition.

Liquid Carrier

In some examples, when printing, the yellow LEP ink composition comprises a liquid carrier. Generally, the liquid carrier can act as a dispersing medium for the other components in the yellow LEP ink composition. For example, the liquid carrier can comprise or be a hydrocarbon, silicone oil, vegetable oil, etc. The liquid carrier can include, but is not limited to, an insulating, non-polar, non-aqueous liquid that can be used as a medium for toner particles. The liquid carrier can include compounds that have a resistivity in excess of about 10⁹ ohm·cm. The liquid carrier may have a dielectric constant below about 5, in some examples below about 3. The liquid carrier can include, but is not limited to, hydrocarbons. The hydrocarbon can include, but is not limited to, an aliphatic hydrocarbon, an isomerized aliphatic hydrocarbon, branched chain aliphatic hydrocarbons, aromatic hydrocarbons, and combinations thereof. Examples of the liquid carriers include, but are not limited to, aliphatic hydrocarbons, isoparaffinic compounds, paraffinic compounds, dearomatized hydrocarbon compounds, and the like. In particular, the liquid carriers can include, but are not limited to, Isopar-G™, Isopar-H™, Isopar-L™, Isopar-M™, Isopar-K™, Isopar-V™, Norpar 12™, Norpar13™, Norpar15™, Exxol D40™, Exxol D80™, Exxol D100™, Exxol D130™, and Exxol D140™ (each sold by EXXON CORPORATION); Teclen N-16™, Teclen N-20™, Teclen N-22™, Nisseki Naphthesol L™, Nisseki Naphthesol M™, Nisseki Naphthesol H™, #0 Solvent L™, #0 Solvent M™, #0 Solvent H™, Nisseki Isosol300™, Nisseki Isosol400™, AF-4™, AF-5™, AF-6™ and AF-7™ (each sold by NIPPON OIL CORPORATION); IP Solvent 1620™ and IP Solvent 2028™ (each sold by IDEMITSU PETROCHEMICAL CO., LTD.); Amsco OMS™ and Amsco 460™ (each sold by AMERICAN MINERAL SPIRITS CORP.); and Electron, Positron, New II, Purogen HF (100% synthetic terpenes) (sold by ECOLINK™).

Before liquid electrophotographic printing, the liquid carrier can constitute about 20% to 99.5% by weight of the yellow liquid electrostatic ink composition, in some examples 50% to 99.5% by weight of the yellow liquid electrostatic ink composition. Before printing, the liquid carrier may constitute about 40% to 90% by weight of the yellow liquid electrostatic ink composition. Before printing, the liquid carrier may constitute about 60% to 80% by weight of the yellow liquid electrostatic ink composition. Before printing, the liquid carrier may constitute about 90% to 99.5% by weight of the yellow liquid electrostatic ink composition, in some examples 95% to 99% by weight of the yellow liquid electrostatic ink composition.

The yellow liquid electrostatic ink composition, once electrostatically printed on the substrate, may be substantially free from liquid carrier. In an electrostatic printing process and/or afterwards, the liquid carrier may be removed, for example, by an electrophoresis processes during printing and/or evaporation, such that substantially just solids are transferred to the substrate. Substantially free from liquid carrier may indicate that yellow liquid electrostatically printed ink contains less than 5 wt. % liquid carrier, in some examples, less than 2 wt. % liquid carrier, in some examples less than 1 wt. % liquid carrier, in some examples less than 0.5 wt. % liquid carrier. In some examples, yellow liquid electrostatically printed ink is free from liquid carrier.

Charge Director

In some examples, the yellow LEP ink composition further includes a charge director. The charge director may be added in order to impart and/or maintain sufficient electrostatic charge on the ink particles, which may be particles comprising the thermoplastic resin. In some examples, the charge director may comprise ionic compounds, particularly metal salts of fatty acids, metal salts of sulfo-succinates, metal salts of oxyphosphates, metal salts of alkyl-benzenesulfonic acid, metal salts of aromatic carboxylic acids or sulfonic acids, as well as zwitterionic and non-ionic compounds, such as polyoxyethylated alkylamines, lecithin, polyvinylpyrrolidone, organic acid esters of polyvalent alcohols, etc. The charge director can be selected from, but is not limited to, oil-soluble petroleum sulfonates (e.g. neutral Calcium Petronate™, neutral Barium Petronate™, and basic Barium Petronate™), polybutylene succinimides (e.g. OLOA™ 1200 and Amoco 575), and glyceride salts (e.g. sodium salts of phosphated mono- and diglycerides with unsaturated and saturated acid substituents), sulfonic acid salts including, but not limited to, barium, sodium, calcium, and aluminum salts of sulfonic acid. The sulfonic acids may include, but are not limited to, alkyl sulfonic acids, aryl sulfonic acids, and sulfonic acids of alkyl succinates. The charge director can impart a negative charge or a positive charge on the resin-containing particles of a yellow LEP ink composition.

In some examples, the yellow liquid electrostatic ink composition comprises a charge director comprising a simple salt. The ions constructing the simple salts are all hydrophilic. The simple salt may include a cation selected from the group consisting of Mg, Ca, Ba, NH₄, tert-butyl ammonium, Li⁺, and Al³⁺, or from any sub-group thereof. The simple salt may include an anion selected from the group consisting of SO₄²⁻, PO₃⁻, NO₃⁻, HPO₄²⁻, CO₃²⁻, acetate, trifluoroacetate (TFA), Cr, BF₄⁻, F⁻, ClO₄⁻, and TiO₃⁴⁻ or from any sub-group thereof. The simple salt may be selected from CaCO₃, Ba₂TiO₃, Al₂(SO₄), Al(NO₃)₃, Ca₃(PO₄)₂, BaSO₄, BaHPO₄, Ba₂(PO₄)₃, CaSO₄, (NH₄)₂CO₃, (NH₄)₂SO₄, NH₄OAc, tert-butyl ammonium bromide, NH₄NO₃, LiTFA, Al₂(SO₄)₃, LiClO₄ and LiBF₄, or any sub-group thereof.

In some examples, the liquid electrostatic ink composition comprises a charge director comprising a sulfosuccinate salt of the general formula MAₙ, wherein M is a metal, n is the valence of M, and A is an ion of the general formula (I): [R¹—O—C(O)CH₂CH(SO₃—)—C(O)—O—R²], wherein each of R¹ and R² is an alkyl group. In some examples each of R¹ and R² is an aliphatic alkyl group. In some examples, each of R¹ and R² independently is a C6-25 alkyl. In some examples, said aliphatic alkyl group is linear. In some examples, said aliphatic alkyl group is branched. In some examples, said aliphatic alkyl group includes a linear chain of more than 6 carbon atoms. In some examples, R¹ and R² are the same. In some examples, at least one of R¹ and R² is C₁₃H₂₇. In some examples, M is Na, K, Cs, Ca, or Ba.

In some examples, the charge director comprises at least one micelle forming salt and nanoparticles of a simple salt as described above. The simple salts are salts that do not form micelles by themselves, although they may form a core for micelles with a micelle forming salt. The sulfosuccinate salt of the general formula MAₙ is an example of a micelle forming salt. The charge director may be substantially free of an acid of the general formula HA, where A is as described above. The charge director may include micelles of said sulfosuccinate salt enclosing at least some of the nanoparticles of the simple salt. The charge director may include at least some nanoparticles of the simple salt having a size of 200 nm or less, and/or in some examples 2 nm or more.

The charge director may include one of, some of or all of (i) soya lecithin, (ii) a barium sulfonate salt, such as basic barium petronate (BBP), and (iii) an isopropyl amine sulfonate salt. Basic barium petronate is a barium sulfonate salt of a 21-26 carbon atom hydrocarbon alkyl, and can be obtained, for example, from Chemtura. An example isopropyl amine sulphonate salt is dodecyl benzene sulfonic acid isopropyl amine, which is available from Croda.

In some examples, the charge director constitutes about 0.001% to 20% by weight, in some examples 0.01% to 20% by weight, in some examples 0.01% to 10% by weight, in some examples 0.01% to 5% by weight of the total solids of a liquid electrostatic ink composition. In some examples, the charge director constitutes about 1% to 4% by weight of the total solids of the liquid electrostatic ink composition, in some examples 2% to 4% by weight of the total solids of the electrostatic ink composition.

In some examples, the charge director is present in an amount sufficient to achieve a particle conductivity of 500 pmho/cm or less, in some examples, 450 pmho/cm or less, in some examples, 400 pmho/cm or less, in some examples, 350 pmho/cm or less, in some examples, 300 pmho/cm or less, in some examples, 250 pmho/cm or less, in some examples, 200 pmho/cm or less, in some examples, 190 pmho/cm or less, in some examples, 180 pmho/cm or less, in some examples, 170 pmho/cm or less, in some examples, 160 pmho/cm or less, in some examples, 150 pmho/cm or less, in some examples, 140 pmho/cm or less, in some examples, 130 pmho/cm or less, in some examples, 120 pmho/cm or less, in some examples, 110 pmho/cm or less, in some examples, about 100 pmho/cm. In some examples, the charge director is present in an amount sufficient to achieve a particle conductivity of 50 pmho/cm or more, in some examples, 60 pmho/cm or more, in some examples, 70 pmho/cm or more, in some examples, 80 pmho/cm or more, in some examples, 90 pmho/cm or more, in some examples, about 100 pmho/cm, in some examples, 150 pmho/cm or more, in some examples, 200 pmho/cm or more, in some examples, 250 pmho/cm or more, in some examples, 300 pmho/cm or more, in some examples, 350 pmho/cm or more, in some examples, 400 pmho/cm or more, in some examples, 450 pmho/cm or more, in some examples, 500 pmho/cm or more. In some examples, the charge director is present in an amount sufficient to achieve a particle conductivity of 50 pmho/cm to 500 pmho/cm, in some examples, 60 pmho/cm to 450 pmho/cm, in some examples, 70 pmho/cm to 400 pmho/cm, in some examples, 80 pmho/cm to 350 pmho/cm, in some examples, 90 pmho/cm to 300 pmho/cm, in some examples, 100 pmho/cm to 250 pmho/cm, in some examples, 110 pmho/cm to 200 pmho/cm, in some examples, 120 pmho/cm to 500 pmho/cm, in some examples, 130 pmho/cm to 450 pmho/cm, in some examples, 140 pmho/cm to 400 pmho/cm, in some examples, 150 pmho/cm to 350 pmho/cm, in some examples, 160 pmho/cm to 300 pmho/cm.

In some examples, the charge director is present in an amount of from 3 mg/g to 50 mg/g, in some examples from 3 mg/g to 45 mg/g, in some examples from 10 mg/g to 40 mg/g, in some examples from 5 mg/g to 35 mg/g, in some examples, 20 mg/g to 35 mg/g, in some examples, 22 mg/g to 34 mg/g (where mg/g indicates mg per gram of solids of the liquid electrostatic ink composition).

Charge Adjuvant

In some examples, the yellow LEP ink composition further includes a charge adjuvant. A charge adjuvant may promote charging of the particles when a charge director is present. The method as described herein may involve adding a charge adjuvant at any stage. The charge adjuvant can include, for example, barium petronate, calcium petronate, Co salts of naphthenic acid, Ca salts of naphthenic acid, Cu salts of naphthenic acid, Mn salts of naphthenic acid, Ni salts of naphthenic acid, Zn salts of naphthenic acid, Fe salts of naphthenic acid, Ba salts of stearic acid, Co salts of stearic acid, Pb salts of stearic acid, Zn salts of stearic acid, Al salts of stearic acid, Zn salts of stearic acid, Cu salts of stearic acid, Pb salts of stearic acid, Fe salts of stearic acid, metal carboxylates (e.g., Al tristearate, Al octanoate, Li heptanoate, Fe stearate, Fe distearate, Ba stearate, Cr stearate, Mg octanoate, Ca stearate, Fe naphthenate, Zn naphthenate, Mn heptanoate, Zn heptanoate, Ba octanoate, Al octanoate, Co octanoate, Mn octanoate, and Zn octanoate), Co lineolates, Mn lineolates, Pb lineolates, Zn lineolates, Ca oleates, Co oleates, Zn palmirate, Ca resinates, Co resinates, Mn resinates, Pb resinates, Zn resinates, AB diblock copolymers of 2-ethylhexyl methacrylate-co-methacrylic acid calcium and ammonium salts, copolymers of an alkyl acrylamidoglycolate alkyl ether (e.g., methyl acrylamidoglycolate methyl ether-co-vinyl acetate), or hydroxy bis(3,5-di-tert-butyl salicylic) aluminate monohydrate. In an example, the charge adjuvant is or includes aluminum di- or tristearate. In some examples, the charge adjuvant is VCA (aluminium stearate and aluminium palmitate, available from Sigma Aldrich).

The charge adjuvant may be present in an amount of about 0.1% to 5% by weight, in some examples about 0.1% to 1% by weight, in some examples about 0.3% to 0.8% by weight of the total solids of the liquid electrostatic ink composition, in some examples, about 1 wt. % to 5 wt. % of the total solids of the liquid electrostatic ink, in some examples about 1 wt. % to 3 wt. % of the total solids of the liquid electrostatic ink composition, in some examples about 1.5 wt. % to 2.5 wt. % of the total solids of the liquid electrostatic ink composition.

The charge adjuvant may be present in an amount of less than 5% by weight of total solids of the liquid electrostatic ink composition, in some examples in an amount of less than 4.5% by weight, in some examples in an amount of less than 4% by weight, in some examples in an amount of less than 3.5% by weight, in some examples in an amount of less than 3% by weight, in some examples in an amount of less than 2.5% by weight, in some examples, in an amount of less than 2% by weight of the total solids of the liquid electrostatic ink composition.

In some examples, the liquid electrostatic ink composition further includes, e.g. as a charge adjuvant, a salt of multivalent cation and a fatty acid anion. The salt of multivalent cation and a fatty acid anion can act as a charge adjuvant. The multivalent cation may, in some examples, be a divalent or a trivalent cation. In some examples, the multivalent cation is selected from Group 2, transition metals and Group 3 and Group 4 in the Periodic Table. In some examples, the multivalent cation includes a metal selected from Ca, Sc, Ti, V, Cr, Mn, Fe, Co, Ni, Cu, Zn, Al and Pb. In some examples, the multivalent cation is Al³⁺. The fatty acid anion may be selected from a saturated or unsaturated fatty acid anion. The fatty acid anion may be selected from a C8 to C26 fatty acid anion, in some examples a C14 to C22 fatty acid anion, in some examples a C16 to C20 fatty acid anion, in some examples a C17, C18 or C19 fatty acid anion. In some examples, the fatty acid anion is selected from a caprylic acid anion, capric acid anion, lauric acid anion, myristic acid anion, palmitic acid anion, stearic acid anion, arachidic acid anion, behenic acid anion and cerotic acid anion.

The charge adjuvant, which may, for example, be or include a salt of a multivalent cation and a fatty acid anion, may be present in an amount of 0.1 wt. % to 5 wt. % of the total solids of the liquid electrostatic ink composition, in some examples in an amount of 0.1 wt. % to 3 wt. % of the total solids of the liquid electrostatic ink composition, in some examples about 1 wt. % to 3 wt. % of the total solids of the liquid electrostatic ink composition, in some examples about 1.5 wt. % to 2.5 wt. % of the total solids of the liquid electrostatic ink composition.

Dispersant

In some examples, the yellow LEP ink composition may further comprise a dispersant. In some examples, the dispersant may be a polymeric dispersant. In some examples, the polymeric dispersant may be a basic polymeric dispersant. In some examples, the polymeric dispersant may be a polymeric amine dispersant. In some examples, the polymeric amine dispersant may be a polyisobutylene succinimide based dispersant.

In some examples, the dispersant, for example, the amine-containing dispersant, may be present in an amount of 3 wt. % or more of the weight of pigment, for example, 4 wt. % or more, 5 wt. % or more, 6 wt. % or more, 7 wt. % or more, 8 wt. % or more, 9 wt. % or more or 10 wt. % or more of the weight of pigment. In some examples, the dispersant, for example, the amine-containing dispersant, may be present in an amount of 10 wt. % or less of the weight of pigment, for example, 9 wt. % or less, 8 wt. % or less, 7 wt. % or less, 6 wt. % or less, 5 wt. % or less, 4 wt. % or less or 3 wt. % or less of the weight of pigment. In some examples, the dispersant, for example, the amine-containing dispersant, may be present in an amount of 3 wt. % to 10 wt. % of the weight of the pigment, for example, 4 wt. % to 9 wt. %, 5 wt. % to 8 wt. % or 6 wt. % to 7 wt. % of the weight of the pigment.

In some examples, the dispersant, for example, the amine-containing dispersant, may be present in the yellow LEP ink composition in an amount of up to about 5 wt. % of the non-volatile solids of the yellow LEP ink composition, for example, about 4.5 wt. % or less, about 4 wt. % or less, about 3.5 wt. % or less, about 3 wt. % or less, about 2.5 wt. % or less, about 2 wt. % or less, about 1.5 wt. % or less, or about 1 wt. % or less of the non-volatile solids of the yellow LEP ink composition. In some examples, the dispersant, for example, the amine-containing basic dispersant may be present in the yellow LEP ink composition in an amount of about 0.1 wt. % or more, for example, about 0.2 wt. % or more, about 0.3 wt. % or more, or about 0.4 wt. % or more, about 0.5 wt. % or more, about 0.2 wt. % or more, about 0.3 wt. % or more, or about 0.4 wt. % or more, or about 0.5 wt. % or more, about 1 wt. % or more, or about 1.5 wt. % or more of the non-volatile solids of the yellow LEP ink composition. In some examples, the dispersant, for example, the amine-containing basic dispersant, may be present in the yellow LEP ink composition in an amount of from 0 wt. % to about 5 wt. % of the non-volatile solids of the yellow LEP ink composition, for example, about 0.1 wt. % to about 5 wt. %, about 0.2 wt. % to about 4.5 wt. %, about 0.3 wt. % to about 4 wt. %, about 0.4 wt. % to about 3.5 wt. %, about 0.5 wt. % to about 3 wt. %, about 1 wt. % to about 2.5 wt. %, or about 1.5 wt. % to about 2 wt. % of the non-volatile solids of the yellow LEP ink composition.

In some examples, the basic polymeric dispersant comprises a basic anchor group, which may be an amine group. In some examples, each basic polymeric dispersant molecule comprises a multi amine anchor group or a single amine anchor group, in some examples each basic polymeric dispersant molecule comprises a multi amine anchor group. In some examples, the basic polymeric dispersant comprises a polyester. In some examples, the basic polymeric dispersant comprises a polyester and an amine anchor group. In some examples, the basic polymeric dispersant comprises a polyester terminated by an amine containing group bound to the polyester through an amide linkage. In some examples, the polymeric amine dispersant comprises a copolymer having pendant stearic acid groups.

In some examples, the basic polymeric dispersant comprises a co-polymer. In some examples, the basic polymeric dispersant comprises a block co-polymer having multiple anchor groups, for example an ABA block co-polymer or a BAB block copolymer or a random copolymer. In some examples, the polymeric dispersant comprises a comb co-polymer.

In some examples, the polymeric dispersant comprises a polysobutylene suiccinimide containing dispersant. In some examples, the polymeric dispersant has the following formula

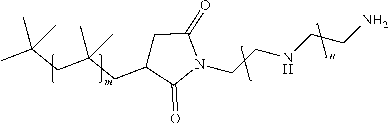

wherein n and m may be are integers of 1 to 1000.

In some examples, the polymeric dispersant may be Solsperse J560 (which is also known as Lubrizol 6406) or OLOA1200.

In some examples, the polymeric amine dispersant is Solplus® P6000 (available from Lubrizol), which has a TBN of about 400 mgKOH/g material.

In some examples, the amine-containing basic dispersant has a total base number (TBN) of at least about 10 mgKOH/g material, in some examples, a TBN of at least about 20 mgKOH/g material, in some examples, a TBN of at least about 30 mgKOH/g material, in some examples, a TBN of at least about 40 mgKOH/g material, in some examples, a TBN of at least about 50 mgKOH/g material, in some examples, 60 mgKOH/g material, in some examples a TBN of at least about 70 mgKOH/g material. In some examples, amine-containing basic dispersant has a TBN of about 100 mgKOH/g material or less, in some examples a TBN of about 90 mgKOH/g material or less, in some examples a TBN of about 80 mgKOH/g material or less, in some examples a TBN of about 70 mgKOH/g material or less, in some examples a TBN of about 60 mgKOH/g material or less. In some examples the basic dispersant has a total base number (TBN) of from about 10 mgKOH/g material to about 100 mgKOH/g material, in some examples from about 20 mgKOH/g material to about 90 mgKOH/g material, in some examples from about 30 mgKOH/g material to about 80 mgKOH/g material, in some examples from about 40 mgKOH/g material to about 70 mgKOH/g material, in some examples from about 10 mgKOH/g material to about 60 mgKOH/g material, in some examples from about 20 mgKOH/g material to about 50 mgKOH/g material.

In some examples, the amine-containing basic dispersant has a total base number (TBN) of from about 300 mgKOH/g material to about 500 mgKOH/g material, in some examples from about 380 mgKOH/g material to about 420 mgKOH/g material, in some examples about 400 mgKOH/g material.

In some examples, the amine-containing basic dispersant has a total base number (TBN) of less than about 500 mgKOH/g material, in some examples less than about 450 mgKOH/g material, in some examples less than about 425 mgKOH/g material, in some examples less than about 420 mgKOH/g material, in some examples less than about 410 mgKOH/g material.

In some examples, the dispersant has a weight average molecular weight (MW) of about 2 kg/mol or more, for example, about 2.1 kg/mol or more, about 2.2 kg/mol or 10 more, about 2.3 kg/mol or more, about 2.4 kg/mol or more, about 2.5 kg/mol or more, about 2.6 kg/mol or more, about 2.7 kg/mol or more, about 2.8 kg/mol or more, about 2.9 kg/mol or more, or about 3 kg/mol. In some examples, the dispersant has a weight average molecular weight (MW) of about 5 kg/mol or less, for example, about 4.9 kg/mol or less, about 4.8 kg/mol or less, about 4.7 kg/mol or less, about 4.6 kg/mol or less, about 4.5 kg/mol or less, about 4.4 kg/mol or less, about 4.3 kg/mol or less, about 4.2 kg/mol or less, about 4.1 kg/mol or less, or about 4 kg/mol. In some examples, the dispersant has a weight average molecular weight (MW) of from about 2 kg/mol to about 5 kg/mol, for example, from about 2.1 kg/mol to about 4.9 kg/mol, from about 2.2 kg/mol to about 4.8 kg/mol, from about 2.3 kg/mol to about 4.7 kg/mol, from about 2.4 kg/mol to about 4.6 kg/mol, from about 2.5 kg/mol to about 4.5 kg/mol, from about 2.6 kg/mol to about 4.4 kg/mol, from about 2.7 kg/mol to about 4.3 kg/mol, from about 2.8 kg/mol to about 4.2 kg/mol, from about 2.9 kg/mol to about 4.1 kg/mol, or from about 3 kg/mol to about 4 kg/mol. In some examples, the dispersant may have a weight average molecular weight of about 3.5 kg/mol.

In some examples, the polymeric amine dispersant may be a solution or dispersion of the active dispersant in a carrier fluid prior to being added to the ink composition. In some examples, the polymeric amine dispersant may be added as a 50 wt. % or more actives solution, for example, a 60 wt. % or more actives solution or a 62 wt. % actives solution in a carrier fluid, such as a mineral oil or dipropylene glycol. The amount of dispersant referred to herein is the amount of the active component of the solution or dispersion.

Other Additives

The yellow LEP ink composition may include another additive or a plurality of other additives. The other additive or plurality of other additives may be added at any stage of the method. The other additive or plurality of other additives may be selected from a charge adjuvant, a wax, a surfactant, viscosity modifiers, and compatibility additives.

The wax may be an incompatible wax. As used herein, “incompatible wax” may refer to a wax that is incompatible with the resin. Specifically, the wax phase separates from the resin phase upon the cooling of the resin fused mixture on a print substrate during and after the transfer of the ink film to the print substrate, e.g. from an intermediate transfer member, which may be a heated blanket. In some examples, the LEP ink composition comprises silica, which may be added, for example, to improve the durability of images produced using the LEP ink. The other additives may constitute 10 wt. % or less of the total solids of the electrostatic ink composition, in some examples, 5 wt. % or less of the total solids of the electrostatic ink composition, in some examples, 3 wt. % or less of the total solids of the electrostatic ink composition.

Printed Substrate

In an aspect, there is provided a printed substrate comprising a substrate; and a yellow liquid electrophotographically printed ink composition disposed thereon (i.e., disposed on the substrate); wherein the yellow liquid electrophotographically printed ink composition comprises: a thermoplastic resin comprising a polymer having acidic side groups; and a colorant comprising a yellow pigment, wherein the yellow pigment comprises a hydrazone compound. In some examples, the colorant is as described herein.

In some examples, the printed substrate may comprise a substrate and a plurality of different ink compositions (e.g., liquid electrophotographically printed ink compositions) on the substrate, at least one of which is a yellow liquid electrophotographically printed ink composition as described above. In some examples, the printed substrate may comprise a substrate and a plurality of different ink compositions (e.g., liquid electrophotographically printed ink compositions) on the substrate, at least one of which is a yellow liquid electrophotographically printed ink composition comprising a thermoplastic resin comprising a polymer having acidic side groups; and a colorant comprising a yellow pigment, wherein the yellow pigment comprises a hydrazone compound.

In some examples, the printed substrate further comprises a liquid electrophotographically printed ink composition selected from a magenta liquid electrophotographically printed ink composition, a cyan liquid electrophotographically printed ink composition, a black liquid electrophotographically printed ink composition; and a mixture of any two thereof. In some examples, the printed substrate further comprises a magenta liquid electrophotographically printed ink composition and a cyan liquid electrophotographically printed ink composition. In some examples, the printed substrate further comprises a magenta liquid electrophotographically printed ink composition, a cyan liquid electrophotographically printed ink composition and a black liquid electrophotographically printed ink composition. In some examples, the printed substrate comprises a substrate; a yellow liquid electrophotographically printed ink composition disposed on the substrate and a further liquid electrophotographically printed ink composition disposed on the substrate, wherein the further liquid electrophotographically printed ink composition is selected from a magenta liquid electrophotographically printed ink composition, a cyan liquid electrophotographically printed ink composition, a black liquid electrophotographically printed ink composition and a combination thereof.

In some examples, the printed substrate comprises a substrate and a yellow liquid electrophotographically printed ink composition disposed on the substrate, wherein the yellow electrophotographically printed ink composition is as described above. In some examples, the printed substrate comprises a substrate and a yellow liquid electrophotographically printed ink composition disposed on the substrate, wherein the yellow liquid electrophotographically printed ink composition is as described above and wherein the yellow liquid electrophotographically printed ink composition is substantially free of carrier liquid. In some examples, the printed substrate comprises a substrate and a yellow liquid electrophotographically printed ink composition disposed on the substrate, wherein the yellow liquid electrophotographically printed ink composition is as described above and wherein the yellow liquid electrophotographically printed ink composition is free of carrier liquid.

In some examples, the yellow liquid electrophotographically printed ink composition forms a layer with a thickness of 1 μm or less when printed at 100% coverage, for example, 0.8 μm or less, 0.7 μm or less, 0.65 μm or less, 0.6 μm or less, 0.55 μm or less, 0.5 μm or less, 0.45 μm or less. In some examples, the yellow electrophotographically printed ink composition forms a layer with a thickness of 0.4 μm to 1 μm when printed at 100% coverage, for example, 0.45 μm to 0.8 μm, 0.5 μm to 0.7 μm, 0.4 μm to 0.65 μm, 0.45 μm to 0.6 μm, 0.45 μm to 0.55 μm, 0.4 μm to 0.5 μm.

Substrate

In some examples, the substrate may be any suitable substrate. In some examples, the substrate may be any suitable substrate capable of having an image printed thereon. The substrate may include a material selected from an organic or inorganic material. The material may include a natural polymeric material, for example, cellulose. The material may include a synthetic polymeric material, for example, a polymer formed from alkylene monomers, including, but not limited to, polyethylene, polypropylene, and co-polymers such as styrene-polybutadiene. The polypropylene may, in some examples, be biaxially oriented polypropylene. The material may include a metal, which may be in sheet form. The metal may be selected from or made from, for instance, aluminium (Al), silver (Ag), tin (Sn), copper (Cu) and mixtures thereof. In an example, the substrate includes a cellulosic paper. In an example, the cellulosic paper is coated with a polymeric material, for example, a polymer formed from styrene-butadiene resin. In some examples, the cellulosic material has an inorganic material bound to its surface (before printing with ink) with a polymeric material, wherein the inorganic material may be selected from, for example, kaolinite or calcium carbonate. In some examples, the substrate is a cellulosic substrate such as paper. In some examples, the cellulosic substrate may be a coated cellulosic substrate. In some examples, a primer may be coated onto the substrate before the electrophotographic ink composition is printed onto the substrate.

In some examples, the substrate may be a plastic film. In some examples, the substrate may be any plastic film capable of having an image printed thereon. The plastic film may include a synthetic polymeric material, for example, a polymer formed from alkylene monomers, including, for example, polyethylene and polypropylene, and co-polymers such as styrene-polybutadiene polymers. The polypropylene may, in some examples, be biaxially orientated polypropylene. In some examples, the plastic film may comprise polyethylene terephthalate.

In some examples, the plastic film is a thin film. In some examples, the plastic film comprises polyethylene (PE), linear low density polyethylene (LLDPE), low density polyethylene (LDPE), medium density polyethylene (MDPE), high density polyethylene (HDPE), polypropylene (PP), cast (cPP) or biaxially oriented polypropylene (BOPP), oriented polyamide (OPA), or polyethylene terephthalate (PET).

In some examples, the substrate comprises a plurality of layers of material laminated together to form a pre-laminated substrate. In some examples, the substrate comprises a plurality of layers of material laminated together to form a pre-laminated substrate in which a plastic film forms the surface onto which electrophotographic ink can be applied. In some examples, the substrate comprises a plurality of layers of film laminated together to form a pre-laminated substrate in which a plastic film forms the surface onto which electrophotographic ink can be applied. In an example, the substrate may be a plastic film laminated to, adhered to or coated on a cellulosic paper. In some examples, the substrate comprises a plurality of layers of material selected from polymeric materials (e.g. polymeric materials selected from PE, LLDPE, MDPE, PP, BOPP, PET and OPA), metallic materials (e.g. metallic foils such as aluminium foil, or metallized films such as met-PET, met-BOPP or any other metalized substrate), paper and combinations thereof. In some examples, the substrate comprises a plurality of layers of film of a plastic material, such as a combination of films selected from PE, LLDPE, MDPE, PP, BOPP, PET and OPA, laminated together to form the pre-laminated substrate. In some examples, the pre-laminated substrate comprises a Paper/Alu/PE, PET/Al/PE, BOPP/met-BOPP or PET/PE laminate.

In some examples, the substrate comprises a thin material, wherein the material has a thickness of 600 μm or less, for example, 250 μm or less, for example, 200 μm or less, for example, 150 μm or less, for example, 100 μm or less, for example, 90 μm or less, for example, 80 μm or less, for example, 70 μm or less, for example, 60 μm or less, for example, 50 μm or less, for example, 40 μm or less, for example, 30 μm or less, for example, 20 μm or less, for example, 15 μm or less. In some examples, the material is about 12 μm in thickness.

In some examples, the substrate comprises a thin material, wherein the material has a thickness of 12 μm or more, for example, 15 μm or more, for example, 20 μm or more, for example, 30 μm or more, for example, 40 μm or more, for example, 50 μm or more, for example, 60 μm or more, for example, 70 μm or more, for example, 80 μm or more, for example, 90 μm or more. In some examples, the material has a thickness of about 100 μm or more, in some examples, about 100 μm or more.

In some examples, the substrate comprises a thin material, wherein the material is from 12 μm to 600 μm in thickness, in some examples, from 15 μm to 250 μm in thickness, in some examples, from 20 μm to 200 μm in thickness, in some examples, from 30 μm to 150 μm in thickness, in some examples, 40 μm to 100 μm in thickness, in some examples, 50 μm to 150 μm, in some examples, 60 μm to 100 μm in thickness, in some examples, 70 to 90 μm in thickness.

Method of Producing a Printed Substrate

In an aspect, there is provided a method of producing a printed substrate comprising applying a yellow liquid electrophotographic ink composition to a substrate with a liquid electrophotographic printer. In some examples, there is provided a method of producing a printed substrate comprising applying a yellow liquid electrophotographic ink composition to a substrate with a liquid electrophotographic printer; wherein the yellow liquid electrophotographic ink composition comprises: a thermoplastic resin comprising a polymer having acidic side groups; and a colorant comprising a yellow pigment, wherein the yellow pigment comprises a hydrazone compound.

In some examples, the method of producing a printed substrate comprises applying a yellow liquid electrophotographic ink composition to a substrate with an electrophotographic printer; wherein the yellow liquid electrophotographic ink composition is as described above.

In some examples, the method of producing a printed substrate comprises applying a plurality of different LEP ink compositions to a substrate with a liquid electrophotographic printer, at least one of which comprises a yellow liquid electrophotographic ink composition as described above. In some examples, the method of producing a printed substrate comprises applying a plurality of different LEP ink compositions to a substrate with a liquid electrophotographic printer, at least one of which consists of a yellow liquid electrophotographic ink composition as described above.

In some examples, the method of producing a printed substrate comprises applying a yellow LEP ink composition to a substrate with an electrophotographic printer, and further comprises applying a black ink composition, a cyan ink composition and a magenta ink composition. In some examples, the method of producing a printed substrate comprises applying a yellow LEP ink composition to a substrate with an electrophotographic printer, and further comprises applying to the substrate, with the electrophotographic printer, a black LEP ink composition, a cyan LEP ink composition and a magenta LEP ink composition.

In some examples, applying an LEP ink composition to a substrate with an electrophotographic printer comprises contacting the LEP ink composition with a latent electrostatic image on a surface to create a developed image and transferring the developed image to the substrate, in some examples, via an intermediate transfer member.

In some examples, the surface on which the (latent) electrostatic image is formed or developed may be a rotating member, for example, in the form of a cylinder. The surface on which the (latent) electrostatic image is formed or developed may form a part of a photo imaging plate (PIP). The method may involve passing the ink composition between a stationary electrode and a rotating member, which may be a member having the surface having the (latent) electrostatic image thereon or a member in contact with the surface having the (latent) electrostatic image thereon. A voltage is applied between the stationary electrode and the rotating member, such that particles adhere to the surface of the rotating member. The intermediate transfer member, if present, may be a rotating flexible member, which may be heated, for example, to a temperature of from 80 to 160° C.

Method of Producing a Yellow Liquid Electrophotographic Ink Composition

In some examples, the method of producing a yellow liquid electrophotographic ink composition may comprise combining a thermoplastic resin and a colorant. In some examples, the method of producing a yellow LEP ink composition may comprise combining a thermoplastic resin, a colorant and a liquid carrier.

In some examples, the method of producing a yellow liquid electrophotographic ink composition may comprise combining a dispersant, a colorant and a thermoplastic resin. In some examples, the method of producing a yellow LEP ink composition may comprise combining a dispersant, a colorant, a thermoplastic resin and a liquid carrier. In some examples, the method of producing a yellow LEP ink composition may comprise combining a colorant and a dispersant with a liquid carrier before adding a thermoplastic resin to the combined colorant and dispersant.

In some examples, combining the colorant and the dispersant comprises grinding the colorant and the dispersant.

In some examples, the dispersant is a liquid or is in the form of a solution and is combined with the colorant to form a slurry before addition of the thermoplastic resin. In some examples, the dispersant is a liquid or is in solution form and is ground with the colorant to form a slurry before addition of the resin, which may be followed by further grinding. In some examples, the dispersant is a solid and is ground with the colorant and the resin (e.g., without first combining the dispersant with the colorant).

In some examples, the thermoplastic resin is combined with a liquid carrier before addition of the colorant. In some examples, the thermoplastic resin is combined with a liquid carrier to form a first composition; the colorant is combined with a liquid carrier to form a second composition; and the first composition is combined with the second composition to form the yellow LEP ink composition. In some examples, the thermoplastic resin is combined with a liquid carrier to form a first composition; the colorant and the dispersant are combined with a liquid carrier to form a second composition; and the first composition is combined with the second composition to form the yellow LEP ink composition. In some examples, the liquid carrier in the first composition is the same or different from the liquid carrier in the second composition. In some examples, the liquid carrier in the first composition is the same as the liquid carrier in the second composition.

In some examples, the method of producing a yellow LEP ink composition comprises adding a charge adjuvant to the yellow LEP ink composition. In some examples, the charge adjuvant may be added to the yellow LEP ink composition before, during or after the colorant and the thermoplastic resin are combined. In some examples, the charge adjuvant may be added to the yellow LEP ink composition before, during or after the colorant, the thermoplastic resin, and the dispersant are combined.

In some examples, the method of producing a yellow LEP ink composition comprises adding a charge director to the yellow LEP ink composition. In some examples, the charge director is added to the yellow LEP ink composition before, during or after the charge adjuvant is added to the yellow LEP ink composition. In some examples, the charge director may be added to the yellow LEP ink composition before, during or after the colorant and the thermoplastic resin are combined. In some examples, the charge director may be added to the yellow LEP ink composition before, during or after the colorant, the thermoplastic resin, and the dispersant are combined.

In some examples, the method of producing a yellow LEP ink composition may comprise suspending a thermoplastic resin in a carrier liquid before adding it to the colorant. In some examples, the method may comprise suspending a first thermoplastic resin and a second thermoplastic resin in a carrier liquid. In some examples, the yellow LEP ink composition comprises chargeable particles comprising a first thermoplastic resin and a second thermoplastic resin. In some examples, the method of producing a yellow LEP ink composition may comprise suspending chargeable particles comprising a first thermoplastic resin and a second thermoplastic resin in a carrier liquid.

In some examples, the method of producing a yellow LEP ink composition may comprise dispersing a first thermoplastic resin and a second thermoplastic resin in a carrier liquid. In some examples, the method of producing a yellow LEP ink composition may comprise dispersing chargeable particles comprising a first thermoplastic resin and a second thermoplastic resin in a carrier liquid.

In some examples, the method of producing a yellow LEP ink composition may comprise combining a thermoplastic resin (for example, the first thermoplastic resin) with the carrier liquid and subsequently adding the other resin (for example, the second resin). In some examples, the method of producing a yellow LEP ink composition comprises combining a resin (for example, the first resin) with the carrier liquid to form a paste and subsequently adding the other resin (for example, the second resin). In some examples, the resin and the carrier liquid are combined and heated to an elevated temperature before adding the other resin, which may have also been heated to an elevated temperature. In some examples, the resin and the carrier liquid are combined and heated to a temperature above the melting point of the resin before adding the other resin, which may have also been heated to a temperature above its melting point. In some examples, the resin and carrier liquid are combined and heated until the resin has melted and/or dissolved in the carrier liquid before adding the other resin. In some examples, adding the other resin to the combined resin and carrier liquid comprises mixing the other resin with the combined resin and carrier liquid.

The melting point of the resin may be determined by differential scanning calorimetry, for example, using ASTM D3418.

In some examples, the resin and the carrier liquid are combined and heated to a temperature of at least 70° C., for example, at least 80° C., for example, at least 90° C., for example, at least 100° C., for example, at least 110° C., for example, at least 120° C., for example, 130° C., for example, to melt the resin. In some examples, the other resin is heated before being added to the combined resin and carrier liquid. In some examples, the other resin is heated to at least 30° C., in some examples, at least 40° C., in some examples, at least 45° C., in some examples, at least 50° C. before being added to the combined resin and carrier liquid. In some examples, the other resin is heated to 100° C. or less, in some examples, 90° C. or less, in some examples, 80° C. or less, in some examples, 75° C. or less, in some examples, 70° C. or less, in some examples, 60° C. or less before being added to the combined resin and carrier liquid. In some examples, the other resin is heated to reduce the viscosity of the other resin before being added to the first resin and the carrier liquid.

In some examples, the method comprises combining the first resin with the carrier liquid to form a first composition; combining the second resin with the carrier liquid to form a second composition; and subsequently combining the first composition and the second composition to form a liquid electrophotographic ink composition. In some examples, the method comprises combining the first resin with the carrier liquid to form a first paste; combining the second resin with the carrier liquid to form a second paste; and subsequently combining the first paste and the second paste to form a liquid electrophotographic ink composition. In some examples, the first resin and the carrier liquid are combined and heated to an elevated temperature to form a first heated composition; the second resin and the carrier liquid are combined and heated to an elevated temperature to form a second heated composition; and subsequently the first heated composition and the second heated composition are combined. In some examples, the first resin and the carrier liquid are combined and heated to a temperature above the melting point of the first resin to form a first heated composition; the second resin and the carrier liquid are combined and heated to a temperature above the melting point of the second resin to form a second heated composition; and subsequently the first heated composition and the second heated composition are combined. In some examples, the first composition and the second composition are heated to the same temperature, which may be a temperature above the melting temperature of all of the resins.

In some examples, the method of producing a yellow LEP ink composition comprises mixing the first resin and the second resin together and then combining the mixture of the resins with the carrier liquid.

In some examples, the first resin and the second resin are combined with the carrier liquid and subsequently heated to an elevated temperature. In some examples, the first resin and the second resin are combined with the carrier liquid and subsequently heated to a temperature above the melting point of at least one, optionally all, of the resins. In some examples, the first resin and the second resin are combined with the carrier liquid and subsequently heated to a temperature of at least 70° C., for example, at least 80° C., for example, at least 90° C., for example, at least 100° C., for example, at least 110° C., for example, at least 120° C., for example, 130° C., for example, to melt at least one, optionally all, of the resins. In some examples, the combined first resin, second resin and carrier liquid are heated until all of the resins have melted and/or dissolved in the carrier liquid.

In some examples, the method of producing a yellow liquid electrophotographic ink composition comprises combining a first resin, a second resin, and a carrier liquid.

In some examples, the chargeable particles comprise the first resin and the second resin.

Melting and/or dissolving a resin (or resins) in the carrier liquid may result in the carrier fluid appearing clear and homogeneous. In some examples, the resin (or resins) and carrier liquid are heated before, during or after mixing.

In some examples, the resin (or resins) and the carrier liquid are mixed at a mixing rate of 500 rpm or less, for example, 400 rpm or less, for example, 300 rpm or less, for example, 200 rpm or less, for example, 100 rpm or less, for example, 75 rpm or less, for example, 50 rpm. In some examples, mixing may continue until melting and/or dissolution of the resin (or resins) in the carrier liquid is complete.

In some examples, after combining and heating the resins and the carrier liquid, the mixture is cooled to a temperature below the melting point of the resins, for example, to room temperature. In some examples, the chargeable particles are removed from the carrier liquid and re-dispersed in a new portion of carrier liquid, which may be the same or a different carrier liquid.

In some examples, the method of producing a yellow LEP ink composition comprises adding a colorant to the combined first resin, second resin and carrier liquid. In some examples, the method of producing a yellow LEP ink composition comprises adding a colorant to the combined first resin, second resin and carrier liquid to form chargeable particles comprising the resins and a colorant. In some examples, the method of producing a yellow LEP ink composition comprises grinding the colorant and the resins in the presence of the carrier liquid to form a paste. In some examples, the method of producing a yellow LEP ink composition comprises heating and mixing the colorant and the resins in the presence of the carrier liquid to form a paste.

In some examples, the method of producing a yellow LEP ink composition comprises adding a charge adjuvant to the combined first resin, second resin and carrier liquid and optionally grinding. In some examples, the method of producing a yellow LEP ink composition comprises adding a charge adjuvant and a colorant to the combined first resin, second resin and carrier liquid and optionally grinding. In some examples, the method of producing a yellow LEP ink composition comprises adding a charge adjuvant to the combined first resin, second resin, colorant and carrier liquid and optionally grinding.

In some examples, the method of producing a yellow LEP ink composition comprises grinding at a grinding speed of at least 50 rpm. In some examples, the method of producing a yellow LEP ink composition comprises grinding at a grinding speed of up to about 600 rpm. In some examples, the method of producing a yellow LEP ink composition comprises grinding for at least 1 h, in some examples, for at least 2 h. In some examples, the method of producing a yellow LEP ink composition comprises grinding for up to about 12 h. In some examples, the method of producing a yellow LEP ink composition comprises grinding at a temperature of at least about 30° C., for example, at least about 35° C., for example, at least about 40° C., for example, at least about 50° C. In some examples, the method of producing a yellow LEP ink composition comprises grinding at a temperature of at least about 50° C. for a first time period, in some examples, for at least 1 h, in some examples, for at least 1.5 h and then reducing the temperature to a temperature of at least 30° C., in some examples, at least 35° C. and continuing grinding for at least 5 h, in some examples, at least 9 h, in some examples, at least 10 h.

In some examples, the method of producing a yellow LEP ink composition comprises adding a charge director to the combined first resin, second resin and carrier liquid. In some examples, the method of producing a yellow LEP ink composition comprises adding a charge director to the combined first resin, second resin, colorant and carrier liquid. In some examples, the method of producing a yellow LEP ink composition comprises adding a charge director to the combined first resin, second resin, charge adjuvant and carrier liquid. In some examples, the method of producing a yellow LEP ink composition comprises adding a charge director to the combined first resin, second resin, colorant, charge adjuvant and carrier liquid.

In some examples, the method of producing a yellow LEP ink composition comprises combining a colorant and a dispersant before the colorant is combined with the other components of the yellow LEP ink composition. In some examples, the method of producing a yellow LEP ink composition comprises combining a colorant and a dispersant in a carrier liquid before the colorant is combined with the other components of the yellow LEP ink composition, which may include additional carrier liquid.

### EXAMPLES

The following illustrates examples of the methods and other aspects described herein.

Thus, these Examples should not be considered as limitations of the present disclosure, but are merely in place to teach how to make examples of the present disclosure.

Materials

Thermoplastic Resin

Nucrel® 699: a copolymer of ethylene and methacrylic acid, made with nominally 11 wt. % methacrylic acid (available form DuPont).

AC-5120: a copolymer of ethylene and acrylic acid with an acrylic acid content of 15 wt. % (available from Honeywell).

Carrier Liquid

Isopar L™: an isoparaffinic oil comprising a mixture of C11-C13 isoalkanes (produced by Exxon Mobil™; CAS number 64742-48-9.

Marcol: a heavy hydrocarbon oil (available from ExxonMobil).

Pigment

Paliotol yellow D 1155: a pigment yellow 185 pigment (available from BASF).

Paliotol yellow D 1819: a pigment yellow 139 pigment (available from BASF).

Ink jet GX-W: a pigment yellow 74 pigment (available from Clariant).

Toner GX: a pigment yellow 74 pigment (available from Clariant).

Sunbrite 2725147: a pigment yellow 74 pigment (available from Sun Chemical).

Sunbrite 2725157: a pigment yellow 74 pigment (available from Sun Chemical).

Dispersant

Solsperse™ J560: a polymeric amine dispersant based on polyisobutylene succinimide (available from Lubrizol), purchased as a 62 wt. % active dispersant in diluent oil.

Charge Adjuvant

VCA: an aluminium stearate (available from Fischer Scientific)

Charge Director

NCD (natural charge director): KT (natural soya lecithin in phospholipids and fatty acids), BBP (basic barium petronate, i.e., a barium sulfonate salt of a 21-26 carbon hydrocarbon alkyl, available from Cemtura™), and GT (dodecyl benzene sulfonic acid isopropyl amine, supplied by Croda™). The composition being 6.6 wt. % KT, 9.8 wt. % BBP and 3.6 wt. % GT and balance (80 wt. %) Isopar L™.

Additives

DS72: AEROSIL® R 7200: a hydrophobic fumed silica (available from Degusa AG).

HPB: Acumist B-6: a polyethylene wax (available from Honeywell).

W12: a polytetrafluoroethylene micronized powder (available from Honeywell).

General Procedure—Preparation of the Electro Photo Graphic Ink Composition

A transparent paste (25 wt. % non-volatile solids (NVS)) was formed by combining Nucrel™ 699, AC-5120™ (in a ratio of 4:1) and Isopar® L in a Ross reactor (Model DPM-2, obtained from Charles Ross & Son Company—Hauppauge N.Y.) at 130° C. and a mixing rate of 50 rpm for 1 h. The mixing rate was then increased to 70 rpm and mixing was continued at 130° C. for a further 1.5 h. The temperature was then gradually reduced to 25° C. over at least 2.5 h under continued mixing at 70 rpm to form the transparent paste.

The transparent paste was then diluted with further Isopar® L and ground with colorant (see Table 1 for amounts) for 12 h in the presence of VCA (see Table 1 for amounts) and DS72 (see Table 1 for amounts) in an 51 attritor at 58° C. and 250 rpm for 1 h, and then at 36° C. and 250 rpm for 10.5 h forming a yellow liquid electrophotographic ink composition.

If a dispersant was used (see Table 1 for amounts), the dispersant and the colorant were combined in Isopar® L by using a Heidolph stirrer (400 rpm at room temperature (approximately 22° C.) for 1 h) or a high shear mixer (at 5000 rpm at room temperature (approximately 25° C.) for 30 min (during high shear mixing, the temperature rises to approximately 50° C.). The transparent paste was then diluted with this mixture and ground for 12 h in the presence of VCA and DS72 in an 51 attritor at 58 C and 250 rpm for 1 h, and then at 36° C. and 250 rpm for 10.5 h forming a yellow liquid electrophotographic ink composition.

Before printing, the yellow liquid electrophotographic ink composition was diluted with Isopar L and Marcol (0.5 wt. % of the total liquid) to 2 wt. % solids to 3 wt. % solids, and a polyethylene wax (HPB, see Table 1 for amounts) and a micronized PTFE powder (W12, see Table 1 for amounts) were added to the dispersion before printing. A charge director (NCD) was then added in an amount of 5 to 100 mg/g of solids on the printing press.

TABLE 1

| | Reference yellow | | Example yellow ink | |
|---|---|---|---|---|
| | ElectroInk 4.5 | | composition | |
| | | wt. % | | wt. % |
| | Material | NVS | Material | NVS |
| Primary Pigment | PY 185 | 10.9 | PY 74 | 18-30 |
| Secondary Pigment | PY 139 | 2.7 | — | 0 |
| Dispersant | — | 0 | Solsperse J560 | 0-1.5 |
| | | | (actives only) | |
| Transparent Paste | Nucrel ™ 699: | 73.8 | Nucrel ™ 699: | 57.08- |
| (25 wt. % NVS) | AC-5120 ™ (4:1) | | AC-5120 ™ (4:1) | 69.08 |
| Charge Adjuvant | VCA | 2.9 | VCA | 1.45 |
| Additives | DS72 | 0.9 | DS72 | 0.97 |
| | HPB | 5.8 | HPB | 6 |
| | W12 | 3 | W12 | 3 |

PY 185: pigment yellow 185; PY 139: pigment yellow 139; PY 74: pigment yellow 74.

Hue, Lightness and Chroma

The hue, lightness and chroma were measured by using an X-rite spectrophotometer to measure the optical density and derive the Cartesian/polar color coordinates from the spectrum under illumination conditions. The results of these measurements are in Table 2. The Reference ink was yellow ElectroInk 4.5 (14 wt. % pigment loading) to which Solsperse J560 had been added. The Example ink contained 22 wt. % Pigment Yellow 74 and 1.1 wt. % Solsperse J560.

TABLE 2

| | Reference yellow | Example yellow ink |
|---|---|---|
| | ElectroInk 4.5 | composition |
| DMA | 0.085 | 0.057-0.062 |
| Optical Density | 1.1 | 1.2 |
| Lightness | 88.5 | 90 |
| a* | −6.4 | −10.5 |
| b* | 88.5 | 98.5 |
| Hue | 94 | 96 |
| Chroma | 89 | 100 |

Four different colorants comprising a pigment consisting of pigment yellow 74 were tested. Printed images using each of these colorants had the same hue, lightness and chroma. Additionally, printed images using each of these colorants had increased chroma and lightness and decreased developed mass per area (DMA) compared to the yellow ElectroInk 4.5 composition.

Yellow ink compositions produced with pigment yellow 74 obtained from Sun chemical provided lower dry ink mass per area (DMA) at an optical density of 1.4 than the yellow ink compositions produced with pigment yellow 74 obtained from other suppliers.

Second Transfer Test

Images were printed using a sheet fed series 3 liquid electrophotographic printer. Transfer of the Example and reference (ElectroInk™ 4.5) liquid electrophotographic ink compositions from the intermediate transfer member to the substrate (the T2 transfer) was compared when printed at 100% coverage (referred to as solid) and about 60% coverage (referred to as gray). Both coated and uncoated paper substrates were used. The results are given in Table 3 below. Images showing a difference compared to the reference images were graded on a scale of −3 to 3, in which −3 is much worse than the reference, 0 is the same as the reference and 3 is much better than the reference.

Y: Yellow ElectroInk™ 4.5, which has a pigment loading of 14 wt. % of the non-volatile solids.

Y1: An Example ink formulation in which the colorant was Sunbrite 2725157 with a pigment loading of 20 wt. % of the non-volatile solids and without a dispersant.

TABLE 3

| Comparison | | Finesse (coated) | | Soperset (uncoated) | | |
|---|---|---|---|---|---|---|
| Ink graded | | Gray | Solid | Gray | Solid | Results |
| Y1 | Y | Y1 > | Y1 > | Y = | Y1 > | For Y1-T2 |
| | | Y1-2 | Y1 | Y10 | Y1.5 | improvement |

The Example yellow liquid electrophotographic ink formulation with high pigment loading (PL 20 wt. %) exhibits better transferability results than the yellow ElectroInk 4.5 composition with only 14 wt. % pigment loading. From these results, it can be deduced that the ink properties have changed due to the replacement of the pigment. This will be discussed in relation to the mechanical properties section.

The T2 transfer of an Example yellow liquid electrophotographic ink composition in which the colorant was Ink jet GX-W (available from Clariant) was also compared to the yellow ElectroInk™ 4.5. This test showed similar results, that is, better T2 transfer for the new formulation.

Peeling Tests

Images were printed using a sheet fade series 3 liquid electrophotographic printer at various coverages (100%, 200%, 300% and 400%) and peeling tests were performed as follows:

An adhesive tape (3M Scotch tape 810) was applied to the heat transfer printed fabric. A heavy roller (2 kg) was rolled over the adhesive tape 4 times. After waiting 10 min, the adhesive tape was removed rapidly at 180° over 2 seconds.

The percentage of ink remaining after the adhesive tape was removed is calculated by scanning the printed image before applying the adhesive tape and after it is removed. The change in the number of white pixels and ink covered pixels is then calculated.

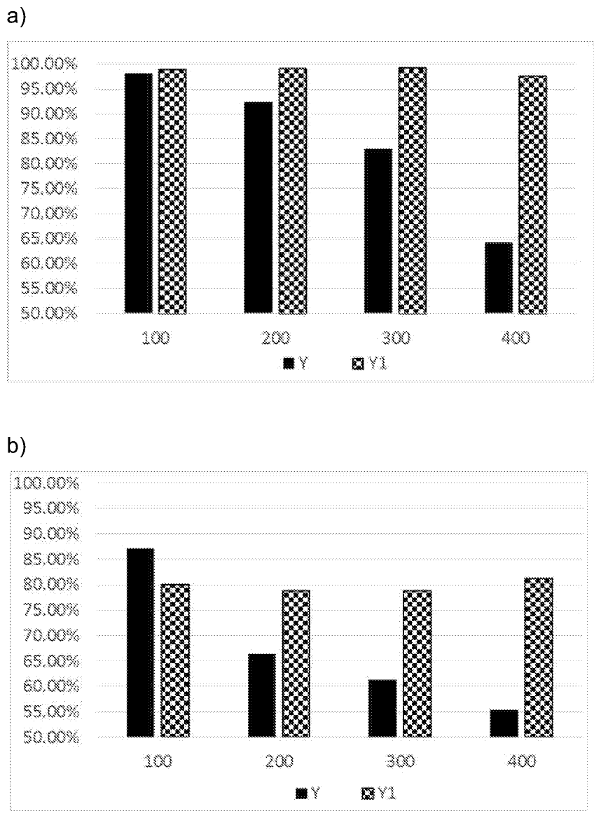

FIG. 1 summarizes the results of peeling tests performed on

Y: Yellow ElectroInk™ 4.5

Y1: An Example ink formulation in which the colorant was Sunbrite 2725157 with a pigment loading of 20 wt. % and without a dispersant.

The Y axis describes the percentage of ink that was left on the substrate after the adhesive tape was removed. It is noticeable that the Example yellow liquid electrophotographic ink composition (Y1) containing the new pigment shows improved peeling resistance at 200%, 300% and 400% solid coverage on both coated and uncoated substrates.

Mechanical Properties

Mechanical properties of three yellow liquid electrophotographic ink compositions were investigated and compared by performing tensile strength tests on the liquid electrophotographically printed ink compositions by using an Instron device. The tested yellow formulations are:

Reference 1: The Yellow ElectroInk™ 4.5 at 14 wt. % pigment loading containing

Pigment Yellow 185 and Pigment Yellow 139.

Reference 2: A higher pigment loading version of the Yellow ElectroInk™ 4.5 formulation at 23 wt. % pigment loading containing Pigment Yellow 185 and Pigment Yellow 139.

Example: A yellow liquid electrophotographic ink composition at 20 wt. % pigment loading containing the Sunbrite 2725157 Pigment Yellow 74 (available from Sun chemical) and 0 wt. % dispersant.

Table 4 summarizes the mechanical properties of 3 inks.

TABLE 4

| | | Young’s | Elongation | Energy at | Tensile |
|---|---|---|---|---|---|
| | Pigment | modulus | at break | break | stress |
| Formulation | loading | [MPa] | [%] | [J] | [MPa] |
| Reference 1 | 14 wt. % | 78 ± 8 | 200 ± 15 | 2.3 ± 0.4 | 11.6 |
| Reference 2 | 23 wt. % | 151 ± 6 | 126 ± 12 | 1.9 ± 0.4 | 12.2 |
| Example | 20 wt. % | 74 ± 4 | 206 ± 11 | 2.3 ± 0.5 | 9.4 |

Increasing the pigment loading of the Reference liquid electrophotographic ink composition from 14 wt. % to 23 wt. % caused the formation of a less elastic printed ink with higher stiffness.

Replacing pigment type with Pigment Yellow 74 (Sunbrite 2725157) led to changes in the mechanical properties of the ink. The Young's modulus and elongation to break of yellow formulation with Pigment Yellow 74 (Example) at 20 wt. % pigment loading are similar to those of Yellow ElectroInk™ 4.5 (Reference 1), which has a pigment loading of 14 wt. % of non-volatile solids. These results may explain the success of the Example yellow ink composition in the T2 transfer tests at high pigment loading.

These results suggest two possible mechanisms for T2 failure at high pigment loading:
Conformability—Higher Young's modulus results in tougher and less flexible printed images, which may cause poor contact between the image on the intermediate transfer member and the substrate.
Film cohesion—Lower elongation to break results in increased brittleness of the printed ink composition, reduced plasticization of the film and lower film cohesion.

Results Summary

The difference in compositions between yellow El 4.5 and the Example yellow formulations are discussed below:
Pigment loading (PL)—Increasing the pigment loading from 14 wt. % to 20-30 wt. % in order to decrease the dry ink mass per area (DMA). By increasing PL to 30 wt. % the Chroma was ˜113 (significantly higher than the Chroma for ElectroInk 4.5, which is 90), which extends the Gamut. A lower PL (e.g., 20 wt. %, or even 14 wt. %) reduces the cost per page but maintains a higher Chroma than ElectroInk 4.5 (14 wt. % NVS pigment).
Secondary pigment—Removal of the secondary pigment increases chroma and expands color gamut.
Pigment type—replacement of the pigment type gives better ink transferability (T2) at high pigment loading and better peeling resistance.
Dispersant—addition of the Solsperse™ J560 dispersant improves color development by dispersing the pigment particles better, resulting in improved color properties. In addition, a reduction in DMA can also be achieved.

While the composition, method and other aspects have been described with reference to certain examples, those skilled in the art will appreciate that various modifications, changes, omissions, and substitutions can be made without departing from the spirit of the disclosure. It is intended, therefore, that the composition, method and other aspects be limited by the scope of the following claims. Unless otherwise stated, the features of any dependent claim can be combined with the features of any of the other dependent claims and any of the independent claims.

1. A yellow liquid electrophotographic ink composition comprising:
a thermoplastic resin comprising a polymer having acidic side groups; and
a colorant comprising a yellow pigment, wherein the yellow pigment comprises a hydrazone compound.

2. The yellow liquid electrophotographic ink composition according to claim 1, wherein the yellow pigment consists of a hydrazone compound.

3. The yellow liquid electrophotographic ink composition according to claim 1, wherein the yellow pigment comprises a hydrazone compound of Formula Ia: 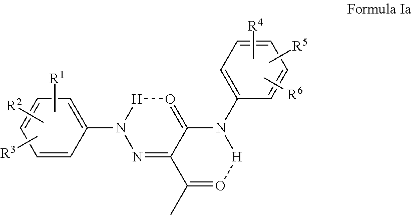
wherein R¹ to R⁶ are each independently selected from a hydrogen atom, a C1 to C3 alkyl group, a C1 to C3 alkoxy group, a nitro group and a halogen group.

4. The yellow liquid electrophotographic ink composition according to claim 3, wherein at least one of R¹ to R³ is a nitro group.

5. The yellow liquid electrophotographic ink composition according to claim 4, wherein a nitro group is para to the hydrazone group.

6. The yellow liquid electrophotographic ink composition according to claim 3, wherein at least one of R¹ to R⁶ is a methoxy group.

7. The yellow liquid electrophotographic ink composition according to claim 6, wherein at least one of R¹ to R³ is a nitro group.

8. The yellow liquid electrophotographic ink composition according to claim 1, wherein the yellow pigment comprises a hydrazone compound of Formula II:

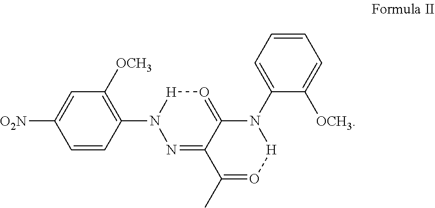

9. The yellow liquid electrophotographic ink composition according to claim 1, wherein the colorant is present in an amount of up to about 30 wt. % of the non-volatile solids of the yellow liquid electrophotographic ink composition.

10. The yellow liquid electrophotographic ink composition according to claim 1, wherein the colorant is present in an amount of from about 15 wt. % to about 35 wt. % of the non-volatile solids of the yellow liquid electrophotographic ink composition.

11. The yellow liquid electrophotographic ink composition according to claim 1, wherein the polymer having acidic side groups is a copolymer of an alkylene monomer and a monomer selected from acrylic acid and methacrylic acid.

12. The yellow liquid electrophotographic ink composition according to claim 1, wherein the yellow pigment consists of a hydrazone compound of formula II

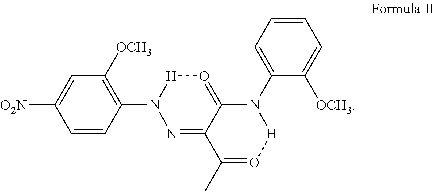

13. A printed substrate comprising
a substrate; and
a yellow liquid electrophotographically printed ink composition disposed thereon;
wherein the yellow liquid electrophotographically printed ink composition comprises:
a thermoplastic resin comprising a polymer having acidic side groups; and
a colorant comprising a yellow pigment, wherein the yellow pigment comprises a hydrazone compound.

14. The printed substrate according to claim 13, wherein the colorant comprises a hydrazone compound of Formula Ia: 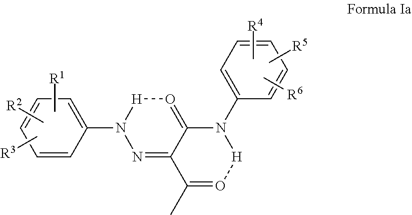
wherein R¹ to R⁶ are each independently selected from a hydrogen atom, a C1 to C3 alkyl group, a C1 to C3 alkoxy group, a nitro group and a halogen group.

15. A method of producing a printed substrate comprising:
applying a yellow liquid electrophotographic ink composition to a substrate with a liquid electrophotographic printer;
wherein the yellow liquid electrophotographic ink composition comprises:
a thermoplastic resin comprising a polymer having acidic side groups; and
a colorant comprising a yellow pigment, wherein the yellow pigment comprises a hydrazone compound.
